(19) United States
(12) Patent Application Publication
(10) Pub. No.: US 2026/0039439 A1
(43) Pub. Date: Feb. 5, 2026

(54) METHODS OF COMMUNICATION, TERMINAL DEVICE, NETWORK DEVICE AND COMPUTER READABLE MEDIUM

(71) Applicant: NEC Corporation, Tokyo (JP)

(72) Inventors: Peng GUAN, Beijing (CN); Yukai GAO, Beijing (CN); Gang WANG, Beijing (CN)

(73) Assignee: NEC Corporation, Tokyo (JP)

(21) Appl. No.: 19/101,387

(22) PCT Filed: Aug. 5, 2022
(86) PCT No.: PCT/CN2022/110651

§ 371 Date: Feb. 5, 2025

(51) Int. Cl. H04L 5/00; H04W 72/232; H04W 76/27

(52) U.S. Cl. CPC H04L 5/0053; H04W 72/232; H04W 76/27

(57) ABSTRACT

Example embodiments of the present disclosure relate to methods of communication, terminal device, network device and a computer readable medium. In an example method, the terminal device may receive from a network device, an indication of at least one update type for updating a first plurality of transmission configuration indication (TCI) states, the indication of at least one update type being determined based on the capability information of the terminal device, and update the first plurality of TCI states based on the at least one update type to obtain a second plurality of TCI states; and then communicate with the network device based on the second plurality of TCI states. As such, there is flexible method to update TCI state for one of TRPs if multiple TCI states mapped to one TCI codepoint in DCI.

### FIELD

Embodiments of the present disclosure generally relate to the field of communication techniques, and in particular, to methods of communication, a terminal device, a network device and a computer readable medium.

### BACKGROUND

In the communication technology, there is a constant evolution ongoing in order to provide efficient and reliable solutions for utilizing wireless communication networks. Each new generation has its own technical challenges for handling different situations and processes that are needed to connect and serve devices connected to wireless networks. To meet the demand for wireless data traffic having increased since deployment of 4th generation (4G) communication systems. efforts have been made to develop an improved 5th generation (5G) or pre-5G communication system. The new communication systems can support various types of service applications for terminal devices.

In Rel-17, unified TCI framework is introduced to replace Rel-15/16 TCI state/spatial relation framework for beam indication. In Rel-18, extending unified TCI framework to support MTRP is in the scope. In RAN1 109e meeting, the discussion is further extended to Rel-18 MTRP scheme(s) with STxMP (if STxMP is supported).

### SUMMARY

In general, example embodiments of the present disclosure provide methods of communication, a terminal device, a network device and a computer readable mcdium.

In a first aspect, there is provided a method of communication. The method comprises: receiving, at a terminal device from a network device, an indication of at least one update type for updating a first plurality of transmission configuration indication (TCI) states, the indication of at least one update type being determined based on first capability information of the terminal device; updating the first plurality of TCI states based on the at least one update type to obtain a second plurality of TCI states; and communicating with the network device based on the second plurality of TCI states.

In a second aspect, there is provided a method of communication. The method comprises: receiving, at a terminal device from a network device, an indication of a plurality of TCI states associated with Transmit/Receive Points (TRPs) with different Physical Cell Identifiers (PCIs); selecting a set of TRPs based on a capability information of the terminal device; and receiving, from the set of TRPs, a common information of a plurality of terminal devices.

In a third aspect, there is provided a method of communication. The method comprises: transmitting, at a network device to a terminal device, an indication of at least one update type for updating a first plurality of transmission configuration indication (TCI) states to a second plurality of TCI states, the indication of at least one update type being determined by the network device based on first capability information of the terminal device; and communicating with the terminal device based on the second plurality of TCI states.

In a fourth aspect, there is provided a method of communication. The method comprises: transmitting, at a network device to a terminal device, an indication of a plurality of TCI states associated with Transmit/Receive Points (TRPs) with different PCIs; determining a set of TRPs selected by the terminal device, the set of TRPs being selected based on capability information of the terminal device; and transmitting, to the terminal device, the common information from the set of TRPs.

In a fifth aspect, there is provided a terminal device. The terminal device comprises: a processor; and a memory storing computer program codes; the memory and the computer program codes configured to, with the processor, cause the terminal device to perform the method according to the first aspect or the second aspect above.

In a sixth aspect, there is provided a network device. The network device comprises: a processor; and a memory storing computer program codes; the memory and the computer program codes configured to, with the processor, cause the network device to perform the method according to the third aspect or the fourth aspect above.

In a seventh aspect, there is provided a computer readable medium having instructions stored thercon, the instructions, when executed on at least one processor, causing the at least one processor to carry out the method according to the first aspect to the fourth aspect above.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Through the more detailed description of some example embodiments of the present disclosure in the accompanying drawings, the above and other objects, features and advantages of the present disclosure will become more apparent, wherein:

FIG. 1 illustrates an example communication system in which some embodiments of the present disclosure can be implemented;

FIG. 2 illustrates schematic diagram of communication between the terminal device and the network device in accordance with some embodiments of the present disclosure;

FIG. 3 illustrates an exemplary format of medium access control (MAC) control element (CE) according to some embodiments of the present disclosure;

FIG. 4 illustrates an exemplary format of MAC CE according to some other embodiments of the present disclosure;

FIG. 5 illustrate an exemplary signalling format according to some embodiments of the present disclosure;

FIG. 6 illustrates a schematic diagram of example interpretation of TCI states mapped to a codepoint according to some embodiments of the present disclosure;

FIG. 7 illustrates an exemplary relationship between C_i and TCI states according to some embodiments of the present disclosure;

FIG. 8 illustrates exemplary relationship between C_i and TCI states according to some other embodiments of the present disclosure;

FIG. 9 illustrates an example of combinations of TCI states mapping to a TCI codepoint via MAC CE according to some embodiments of the present disclosure;

FIG. 10 illustrates an exemplary MAC CE format according to some other embodiments of the present disclosure;

FIG. 11 illustrates an example of combinations of TCI states mapping to a TCI codepoint via MAC CE according to other embodiments of the present disclosure;

FIG. 12 illustrates exemplary MAC CE formats according to some other embodiments of the present disclosure;

FIG. 13 illustrates an exemplary scenario of update at least one of the multiple beams according to some embodiments of the present disclosure;

FIG. 14 illustrates an example of all possible combinations the TCI states mapping to a TCI codepoint according to some embodiments of the present disclosure;

FIG. 15 illustrates a schematic diagram of information the first/second/third/fourth explicitly indicated via adding additional bit(s) in a TCI field according to some embodiments of the present disclosure;

FIG. 16 illustrates a schematic diagram of communication between the terminal device with multiple TRPs according to some embodiments of the present disclosure;

FIG. 17 illustrates a schematic diagram of communication between the terminal device with multiple TRPs according to some other embodiments of the present disclosure;

FIG. 18 illustrates a schematic diagram of some MAC CE formats of the TCI states mapping to a TCI codepoint according to some embodiments of the present disclosure;

FIG. 19 illustrates a schematic diagram of communication between the terminal device and the network device according to some other embodiments of the present disclosure;

FIG. 20 illustrates a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well. unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

In some examples, values, procedures, or apparatus are referred to as “best,” “lowest,” “highest,” “minimum,” “maximum,” or the likc. It will be appreciated that such descriptions are intended to indicate that a selection among many used functional alternatives can be made, and such selections need not be better, smaller, higher, or otherwise preferable to other selections.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G), 5.5G, 5G-Advanced networks, or the sixth generation (6G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used hercin, the term “terminal device” refers to any device having wireless or wired communication capabilities. Examples of terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Space borne vehicles or Air borne vehicles in Non-terrestrial networks (NTN) including Satellites and High Altitude Platforms (HAPs) encompassing Unmanned Aircraft Systems (UAS), extended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also be incorporated one or multiple Subscriber Identity Module (SIM) as known as Multi-SIM. The term “terminal device” can be used interchangeably with a UE, a mobile station, a subscriber station, a mobile terminal, a user terminal or a wireless device.

As used herein, the term “network device” refers to a device which is capable of providing or hosting a cell or coverage where terminal devices can communicate. Examples of a network device include, but not limited to, a satellite, a unmanned aerial systems (UAS) platform, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), and the like.

Communications discussed herein may conform to any suitable standards including, but not limited to, New Radio Access (NR), Long Term Evolution (LTE), LTE-Evolution, LTE-Advanced (LTE-A), Wideband Code Division Multiple Access (WCDMA), Code Division Multiple Access (CDMA), cdma2000, and Global System for Mobile Communications (GSM) and the like. Furthermore, the communications may be performed according to any generation communication protocols either currently known or to be developed in the future. Examples of the communication protocols include, but not limited to, the first generation (1G), the second generation (2G), 2.5G, 2.85G, the third generation (3G), the fourth generation (4G), 4.5G, the fifth generation (5G), and the sixth (6G) communication protocols. The techniques described herein may be used for the wireless networks and radio technologies mentioned above as well as other wireless networks and radio technologies. The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols. 5.5G, 5G-Advanced networks. or the sixth generation (6G) networks.

The terminal device or the network device may have Artificial intelligence (AI) or machine learning capability. It generally includes a model which has been trained from numerous collected data for a specific function, and can be used to predict some information.

The terminal device or the network device may work on several frequency ranges. e.g. FR1 (410 MHz-7125 MHz), FR2 (24.25 GHz to 71 GHz), frequency band larger than 100 GHz as well as Tera Hertz (THz). It can further work on licensed/unlicensed/shared spectrum. The terminal device may have more than one connection with the network device under Multi-Radio Dual Connectivity (MR-DC) application scenario. The terminal device or the network device can work on full duplex, flexible duplex and cross division duplex modes.

The embodiments of the present disclosure may be performed in test equipment, e.g., signal generator, signal analyzer, spectrum analyzer, network analyzer, test terminal device, test network device, or channel emulator.

The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

As used herein, the singular forms “a”, “an” and “the” are intended to include the plural forms as well, unless the context clearly indicates otherwise. The term “includes” and its variants are to be read as open terms that mean “includes, but is not limited to.” The term “based on” is to be read as “based at least in part on.” The term “one embodiment” and “an embodiment” are to be read as “at least one embodiment.” The term “another embodiment” is to be read as “at least one other embodiment.” The terms “first,” “second,” and the like may refer to different or same objects. Other definitions, explicit and implicit, may be included below.

In some examples, values, procedures, or apparatus are referred to as “best,” “lowest,” “highest,” “minimum,” “maximum,” or the like. It will be appreciated that such descriptions are intended to indicate that a selection among many used functional alternatives can be made, and such selections need not be better, smaller, higher, or otherwise preferable to other selections.

In the present disclosure, some terms may refer to same or similar physical meaning and may be used interchangeably. Some examples are listed as below.
The terms “PDCCH/PDSCH transmission”, “PDCCH/PDSCH reception”, “monitor PDCCH/PDSCH” and “PDCCH/PDSCH DMRS port assumption” can be used interchangeably;
The terms “transmission capability information”, “UE capability information”, “capability-related information”, “capability value set”, “panel information” and “panel-related information” can be used interchangeably;
The terms “precoder”, “precoding”, “precoding matrix”, “beam”, “spatial relation information”, “spatial relation info”, “precoding information”, “precoding information and number of layers”, “precoding matrix indicator (PMI)”, “precoding matrix indicator”, “transmission precoding matrix indication”, “precoding matrix indication”, “TCI state”, “transmission configuration indicator”, “quasi co-location (QCL)”, “quasi-co-location”, “QCL parameter”, “QCL assumption”, “QCL relationship” and “spatial relation” can be used interchangeably;
The terms “TRP”, “TCI state”, “TCI”, “control resource set (CORESET)”, “CORESET pool” can be used interchangeably;
The terms “multiple TRPs”, “multiple TCI states”, “multiple CORESETs” and “multiple control resource set pools”, “multi-TRP”, “multi-TCI state”, “multi-TCI”, “multi-CORESET” and “multi-control resource set pool”, “MTRP” and “M-TCI”, “M-TPR” can be used interchangeably;
The terms “resource(s)”, “resource(s) in a resource set”, “resource set” can be used interchangeably; and
The terms “group”, “subset”, “set” can be used interchangeably.
As used herein, the term “TRP” refers to an antenna array (with one or more antenna elements) available to the network device located at a specific geographical location. Although some embodiments of the present disclosure are described with reference to a scenario of multi-TRPs (or a scenario of single TRP) for example, these embodiments are only for the purpose of illustration and help those skilled in the art to understand and implement the present disclosure. without suggesting any limitations as to the scope of the present disclosure. It is to be understood that the present disclosure described herein can be implemented in various manners other than the ones described below.
As used herein, the term “network”/“network device(s)” refer to one or more network devices. Accordingly, terms “network”, “network device(s)” and “one or more network devices” can be used interchangeably.
“BWP ID/index” can be used interchangeably with “BWP/CC ID/index”, “CC identity/index”, “cell identity/index” ”, “physical cell identity/index”, “PCI”. “physCellId” and “serving cell identity/index”.
“TCI state” can be used interchangeably with “TCI state ID”, “RS ID”, “QCL info” and “beam ID”.
“codepoint” can be used interchangeably with “code value”, “bitmap”, “bit value”, “field value” and “payload”.

In order to introduce the technology of this disclosure more clearly, firstly, introduce 3GPP specs. According to 3GPP specs on TCI state indication, beam indication is used for NW (network) to provide beam information to UE about which beam to use for transmitting/receiving. How to decide suitable beam is up to NW algorithm and information collected during beam measurement and report from UE. For DL, it is done based on ‘TCI state’; for UL, it is done based on ‘Spatial relation’, in Rel-17, it is possible to introduce ‘UL TCI’, or ‘joint TCI’ which is used for both DL/UL. Current 3GPP spec adopt ‘QCL’ concept, e.g., ‘two antenna ports are ‘QCLed’ with respect to spatial Rx parameters’ means the transmissions from these two antenna ports should share the same Rx beam from UE perspective. For short, PDSCH using the same beam as a CSI-RS, in spec, it reads ‘QCL relationship between the DM-RS ports of the PDSCH and the CSI-RS port(s) of a CSI-RS resource.’

According to High-level concept on general procedure for DL beam indication, in step 1. radio resource control (RRC) configures a list of TCI states, in Rel-15/16, this list is configured per CC per BWP; In Rel-17, there is discussion about configuration per CC group. In step 2, MAC CE activates a subset of TCI states configured by RRC, or MAC CE indicates a TCI state configured by RRC. ‘Activation’ is the wording used for PDSCH TCI states. Activation command is also used to map TCI state ID to codepoint of TCI field in downlink control information (DCI). ‘Activation’ means that for corresponding activated TCI states, UE is required to tune its Rx parameters including Rx beams, time/frequency sync., etc., to be prepared to use this TCI state for receiving immediately if it is indicated in next step. Alternative wording: UE tracks those TCI states. UE can ‘track’ because NW is transmitting corresponding reference signals, wherein ‘track’ means more power and complexity than simply ‘measure RSRP/SINR’, and ‘indication’ is the wording used for PDCCH TCI states. In next step (step 3), TCI field in DCI indicates TCI state(s) for PDSCH from activated subset of TCI states. If TCI filed is not present in DCI, PDSCH bcam follows PDCCH.

Related capacities mainly include maxNumberConfiguredTCIstatesPerCC, maxNumberActiveTCI-PerBWP, timeDurationForQCL. Respectively, UE informs NW about its max, supported number of configured TCI states, active TCI states and time length required for adjusting its Rx parameters (beams) and/or decoding DCI containing TCI state information.

A TCI state configuration can contain corresponding ID, QCL type and corresponding reference signal. TCI States Activation/Deactivation for UE-specific PDSCH MAC CE, this MAC CE is used to activate a subset of TCI states for UE, also used to map TCI state ID to codepoint of TCI field in DCI. TCI State Indication for UE-specific PDCCH MAC CE, this MAC CE is used to indicate a specific TCI state for PDCCH, per CORESET. UE need to ACK the correct reception of PDSCH carrying this MAC CE. The indicated TCI state will be applied 3 ms after ACK. As an example, the TCI state configuration may be transmitted from a base station to a UE via a RRC message.

If tci-PresentInDCI (which is RRC IE) is enabled, DCI format used to schedule dedicated PDSCH (e.g., DCI format 1_1) contains a 3-bit TCI field, otherwise, PDSCH bcam would follow PDCCH beam (scheduling CORESET). If TCI filed is contained in DCI. the indicated TCI state is applied to PDSCH if time offset between PDCCH and PDSCH is larger than a threshold, which is based on UE capability timcDurationForQCL. if offset<threshold, PDSCH beam is a spec-defined default, which is basically PDCCH beam (CORESET with lowest ID). It can be called as time offset delay_2, which is counted in number of symbols like 7, 14, 28.

UE is only capable of actively tracking a few TCI states (up to 8). but can be configured with more (up to 64). MAC CE activation is used to ask UE to track a subset of TCI states, the delay_1 is defined in RAN4. The TCI state is known if the following conditions are met: During the period from the last transmission of the RS resource used for the L1-RSRP measurement reporting for the target TCI state to the completion of active TCI state switch, where the RS resource for L1-RSRP measurement is the RS in target TCI state or QCLed to the target TCI state. TCI state switch command is received within 1280 ms upon the last transmission of the RS resource for beam reporting or measurement. The UE has sent at least 1 L1-RSRP report for the target TCI state before the TCI state switch command. The TCI state remains detectable during the TCI state switching period. The SSB associated with the TCI state remain detectable during the TCI switching period. SNR of the TCI state ≥−3 dB.

TCI state switch requires less time delay_2, which is related to UE capability, usually 1-2 slots. NW updates the TCI decision and signal to UE.

According to beam indication introduced in Rel-15/16. for target channel/signal, UE should assume same transmit/receive beam as for reference signal. Therefore, information containing reference signal index is the beam indication. More specifically, in DL TCI indication, different TCI indication schemes may be for different channels/signals, and For PDCCH, it may be the form of RRC (configuration)+MAC CE (indication). For PDSCH, it may be the form of RRC (configuration)+MAC CE (activation)+DCI RRC (configuration)+MAC CE (indication). In UL spatial relation indication, different spatial relation indication schemes may be for different channels/signals, and for PUCCH, it may be the form of RRC (configuration)+MAC CE (indication). For PUSCH, DCI indicating SRI, SRI points to SRS resource, wherein for SRS resource, it may be the form of RRC (configuration)+MAC CE (indication).

Unified TCI state provides reference signal to determine QCL relationship, Tx beam. Uplink-powerControl and pathloss reference RS. Two types of unified TCI states arc DL or joint, and UL. Or, three types (for discussion purpose) of unified TCI states are Joint, DL and UL.

Specify extension of Rel-17 Unified TCI framework for indication of multiple DL and UL TCI states focusing on multi-TRP use case, using Rel-17 unified TCI framework. On unified TCI framework extension, consider all the intra and inter-cell MTRP schemes specified in Rel-16 and Rel-17, and Consider. if STxMP is supported, Rel-18 MTRP scheme(s) with STxMP. On unified TCI framework extension at least for single-DCI based MTRP, the existing TCI field in DCI format 1_1/1_2 (with or without DL assignment) can indicate multiple joint/DL/UL TCI states in a CC/BWP or a set of CCs/BWPs in a CC list. There are some problems for further study (FFS), including: detail of mapping joint/DL/UL TCI state ID(s) to a TCI codepoint, e.g., possible combinations of joint, DL, and/or UL TCI state IDs that can be mapped to a TCI codepoint; whether to increase the max number of MAC CE activated TCI codepoints. i.e., more than 8 codepoints: whether to increase the max number of TCI field bits, i.e., more than 3 bits. It should be noted that this doesn't imply that support of one additional TCI field or a field associating the TCI field to the TRP(s) is precluded, and the term TRP is used only for the purposes of discussions in RAN1 and whether/how to capture this is FFS.

On unified TCI framework extension for M-DCI based MTRP, consider the following alternatives (Alt1 to Alt4) for TCI state update. Alt1: Reuse the same TCI state update scheme for S-DCI based MTRP. Atl2: Use the existing TCI field in the DCI format 1_1/1_2 (with or without DL assignment) associated with one of CORESETPoolIndex values to indicate the joint/DL/UL TCI state(s) corresponding to the same CORESETPoolIndex value. Alt3: Use the existing TCI field in any DCI format 1_1/1_2 (with or without DL assignment) to indicate all joint/DL/UL TCI states corresponding to both CORESETPoolIndex values. It may study the association between the indicated joint/DL/UL TCI state(s) and a CORESETPoolIndex value. Alt4: Use the existing TCI field in the DCI format 1_1/1_2 (with or without DL assignment) associated with one of CORESETPoolIndex values to indicate joint/DL/UL TCI state(s) corresponding to the same or different CORESETPoolIndex value. It may study whether the indicated joint/DL/UL TCI state(s) applies to the channels/signals associated with the same CORESETPoolIndex value or different CORESETPoolIndex value is indicated by DCI.

On unified TCI framework extension for S-DCI based MTRP, consider at least the following alternatives (Alt1 to Alt5) to map/associate a joint/DL TCI state to PDCCH reception(s). Alt1: Use RRC configuration to inform the mapping/association between a configured or indicated joint/DL TCI state and a CORESET or a CORESET group. Alt2: Use RRC configuration to inform the mapping/association between a configured or indicated joint/DL TCI state and a search space set. Alt3: Use MAC-CE to inform the mapping/association between an activated or indicated joint/DL TCI state and a CORESET or a CORESET group. Alt4: Use DCI to inform the mapping/association between an indicated joint/DL TCI state and a CORESET or a CORESET group. Alt5: Based on a fixed mapping/association rule, e.g., the first indicated joint/DL TCI state always applies to PDCCH receptions. Consider above alternatives for PDCCH repetition, PDCCH-SFN, PDCCH w/o repetition/SFN, and potential support of dynamic switching between S-TRP and M-TRP for PDCCH. It is not precluded to adopt one single alternative or multiple alternatives to support these cases.

Current 3GPP meeting discussion refer to some proposals. these proposals will be described in detail below. The discussion is on unified TCI framework extension, and it mainly consider at least all the MTRP schemes specified in Rel-16 and Rel-17 as follows: Rcl-16 M-DCI based MTRP schemes for PDSCH and PUSCH; Rcl-16 S-DCI bascd PDSCH SDM scheme; Rel-16 S-DCI based PDSCH FDM and TDM schemes: Rel-17 S-DCI based PUSCH TDM schemes; Rel-17 S-DCI based PDCCH repetition scheme; Rel-17 S-DCI based PUCCH TDM schemes; Rel-17 PDCCH-SFN and PDSCH-SFN; Rel-17 inter-cell MTRP based on M-DCI based MTRP schemes for PDSCH; Consider, if STxMP is supported, Rel-18 MTRP scheme(s) with STxMP.

The discussion is on unified TCI framework extension, support up to 4 indicated TCI states in a CC/BWP for MTRP operation. The indicated TCI states are updated by MAC-CE or DCI with the necessary MAC-CE based TCI state activation. The UE can be configured/provided with one of the following combinations with 2 sets of indicated TCI states for DL and/or UL MTRP operations in a CC/BWP: 1 indicated joint TCI state+1 indicated joint TCI state; 1 pair of indicated DL and UL TCI states+1 pair of indicated DL and UL TCI states; 1 pair of indicated DL and UL TCI states+1 indicated DL TCI state; 1 pair of indicated DL and UL TCI states+1 indicated UL TCI state. For futher study, sets of indicated states may be: 1 indicated joint TCI state+1 pair of indicated DL and UL TCI states, or 1 indicated joint TCI state+1 indicated DL TCI state, or 1 indicated joint TCI state+1 indicated UL TCI state. In addition, how to configure/determine one of above combinations for a CC/BWP, and details of update and activation for the indicated TCI states for S-DCI based MTRP, and details of update and activation for the indicated TCI states for M-DCI based MTRP, and how to map/apply one or more indicated TCI states to a target channel/signal are for further study.

The discussion is on unified TCI framework extension for S-DCI based MTRP, if two joint/DL TCI states are indicated, consider at least the following alternatives (Alt1 to Alt5) to select one or two joint/DL TCI state(s) from the two indicated joint/DL TCI states for PDSCH reception(s). Alt1: Introduce a field (other than the existing TCI field) in a scheduling/activation DCI to indicate the selection. Alt2: Use the TDRA in a scheduling/activation DCI to indicate the selection. Alt3: Use the existing TCI field to indicate the selection. Alt4: Use RRC configuration and/or MAC CE indication to inform the mapping/association between a configured or indicated joint/DL TCI state and PDSCH reception. Alt5: Based on a fixed mapping/association rule, e.g., the first indicated joint/DL TCI state always applies to PDSCH reception. It should be noted that other alternatives are not precluded. Study, when two joint/DL TCI states are selected for the corresponding PDSCH reception, the mapping between the two selected joint/DL TCI states and PDSCH Tx occasions, non-overlapping FDRAs, and CDM groups, and it is not precluded to reusc the Rel-16 mapping rule.

The discussion is on unified TCI framework extension for M-DCI based MTRP. consider at least the following alternatives (Alt1 to Alt3) to map/associate a joint/DL TCI state to PDCCH reception(s) on a CORESET that shares the indicated joint/DL TCI state(s). Alt1: For a CORESET configured/associated with one of CORESETPoolIndex valucs. the UE should apply the indicated joint/DL TCI state corresponding to the CORESETPoolIndex value to PDCCH reception(s) on the CORESET. Alt2: Use RRC configuration other than CORESETPoolIndex to inform the mapping/association between a configured or indicated joint/DL TCI state and a CORESET or a CORESET group. Alt3: Use RRC configuration other than CORESETPoolIndex to inform the mapping/association between a configured or indicated joint/DL TCI state and a search space set.

The discussion is on unified TCI framework extension, study the followings for RRC-configured TCI state list(s). The first is whether to introduce TCI state list(s) per each TRP, and the second is whether to increase the max number of configured TCI states in the joint/DL TCI state list and the UL TCI state list.

The following is an introduction to MAC CE TCI States Activation/Deactivation. The TCI codepoint to which the TCI states are mapped is determined by its ordinal position among all the TCI codepoints with sets of TCI state IDi,j fields, i.e. the first TCI codepoint with TCI state ID0,1 and TCI state ID0,2 shall be mapped to the codepoint value 0, the second TCI codepoint with TCI state ID1,1 and TCI state ID1,2 shall be mapped to the codepoint value 1 and so on. The TCI state IDi,2 is optional based on the indication of the Ci field. The maximum number of activated TCI codepoint is 8 and the maximum number of TCI states mapped to a TCI codepoint is 2.

For TCI field in DCI. the number of bits of transmission configuration indication (TCI) is 0 bit if higher layer parameter tci-PresentInDCI is not enabled; otherwise 3 bits as defined in Clause 5.1.5 of [TS 38.214]. If “Bandwidth part indicator” field indicates a bandwidth part other than the active bandwidth part, and if the higher layer parameter tci-PresentInDCI is not enabled for the CORESET used for the PDCCH carrying the DCI format 1_1, then the UE assumes tci-PresentInDCI is not enabled for all CORESETs in the indicated bandwidth part, otherwise, the UE assumes tci-PresentInDCI is enabled for all CORESETs in the indicated bandwidth part.

As introduced above, 3-bit TCI field is quite limited to signal TCI state combinations for MTRP, and there is not flexible method to update TCI state for one of TRPs if multiple TCI states mapped to one TCI codepoint in DCI. For example, TCI state ID 2 and TCI state ID 10 are mapped to TCI codepoint 2, then, if TCI codepoint is 2 (i.e., 3-bit 010). the activated TCI states are 2 and 10. 3-bit TCI field can only indicate a very limited subset of TCI combinations. Up to 8 combinations of TCI states is already quite limited considering DLorJoint TCI states, and the problem becomes more severe if UL TCI states is used. TCI states mapped to one codepoint cannot be flexible updated is also to be solved.

In addition, UE is not required to monitor SI/paging/short message from two cells with different PCIs according to Rel-17 discussion between RAN1 and RAN2. In Rel-17, only 1 unified TCI state is indicated, therefore it is either associated with the serving cell TRP or the TRP with different PCI. In Rel-17, if UE is receiving DL data from TRP with different PCI on dedicated channels, the UE cannot be able to receive short message (e.g. paging) and system information from serving cell TRP at the same time. If more than 1 unified TCI states are indicated in Rel-18, it is possible that they are associated with both serving cell TRP and the TRP with different PCI simultaneously. How to receive short message and system information when more than 1 unified TCI states are indicated is to be solved.

Embodiments of the present disclosure provide solutions of communication, more specially, provide solutions to update unified TCI state. In some embodiments, the application scenarios including MTRP (multi-Transmit/Receive Point), additionally or alternatively, in some embodiments, the application scenarios including STxMP (simultaneous transmission cross multi-panel) for MPUE (multi-panel UE). Principles and implementations of the present disclosure will be described in detail below with reference to the figures.

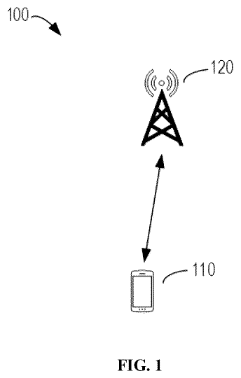

FIG. 1 illustrates an example communication system 100 in which some embodiments of the present disclosure can be implemented. The communication system 100, which is a part of a communication network, includes a network device 120 and a terminal device 110.

The network device 120 can provide services to the terminal device 110, and the network device 120 and the terminal device 110 may communicate data and control information with each other. In some embodiments, the network device 120 and the terminal device 110 may communicate with direct links/channels.

In the system 100, a link from the network devices 120 to the terminal device 110 is referred to as a downlink (DL), while a link from the terminal device 110 to the network devices 120 is referred to as an uplink (UL). In downlink, the network device 120 is a transmitting (TX) device (or a transmitter) and the terminal device 110 is a receiving (RX) device (or a receiver). In uplink, the terminal device 110 is a transmitting TX device (or a transmitter) and the network device 120 is a RX device (or a receiver).

It is to be understood that the network device 120 may provide one or more serving cells. In some embodiments, the network device 120 can provide multiple cells. The network device 120 can correspond to multiple TRPs, and communication with the terminal device 110 by the multiple TRPs.

The communications in the communication system 100 may conform to any suitable standards including, but not limited to, Long Term Evolution (LTE), LTE-Evolution, LTE-Advanced (LTE-A), Wideband Code Division Multiple Access (WCDMA), Code Division Multiple Access (CDMA) and Global System for Mobile Communications (GSM) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G), 5.5G, 5G-Advanced networks, or the sixth generation (6G) communication protocols.

It is to be understood that the numbers of devices and their connection relationships and types shown in FIG. 1 are only for the purpose of illustration without suggesting any limitation. The communication system 100 may include any suitable numbers of devices adapted for implementing embodiments of the present disclosure.

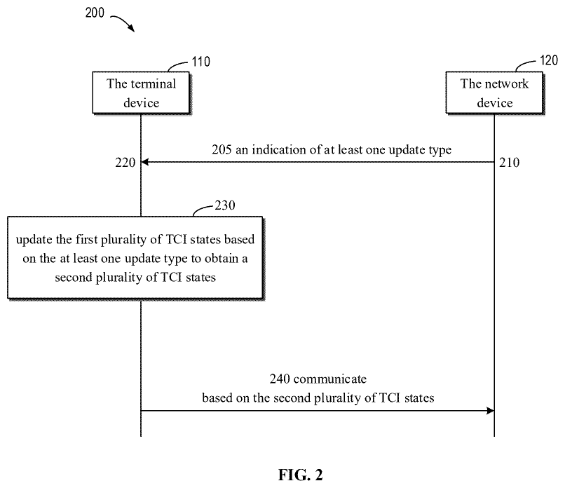

FIG. 2 illustrates schematic diagram of communication between the terminal device 110 and the network device 120 in accordance with some embodiments of the present disclosure. As method 200 shown in FIG. 2, the network device 120 may transmit (210) to a terminal device 110, an indication of at least one update type (205) for updating a first plurality of transmission configuration indication (TCI) states to a second plurality of TCI states, the indication of at least one update type may be determined by the network device 120 based on capability information (first capability information) of the terminal device 110. Accordingly, the terminal device 110 may receive (220) from the network device 120, the indication of at least one update type. The terminal device 110 may update (230) the first plurality of TCI states based on the at least one update type to obtain a second plurality of TCI states. The terminal device 110 and the network device 120 may communicate (240) based on the second plurality of TCI states.

In this way, the present disclosure can provide a flexible method to update TCI state for one of TRPs if multiple TCI states mapped to one TCI codepoint in DCI.

In some embodiments, the network device 120 may transmit to the terminal device 110, an indication of at least one combination type for determining the first plurality of TCI states by the terminal device 110, the indication of at least one combination type may be determined by the network device 120 based on capability information (second capability information) of the terminal device 110. On the other side of communication, at the terminal device 110, the terminal device 110 may receive from the network device 120, the indication of at least one combination type.

It should be noted that the indication of at least one combination type can be used independent from the indication of at least one update type, in other words, the network device 120 can transmit the indication of at least one combination type but do not transmit indication of at least one update type in one communication flow.

The following is a detailed introduction to the indication of at least one combination type. In some embodiments, TCI state activation/deactivation signalling contains at least TCI state combination type information, for example, the TCI state combination type information may be TCI state combination type indication for indicating a TCI state combination type corresponding to a TCI codepoint, or the number of TCI states corresponding to a TCI codepoint, or possible TCI state combination types corresponding to a TCI codepoint, and so on. As an example, the TCI state combination type can be indicated by a base station to a UE via a MAC CE.

In this way, the embodiments of the present disclosure can provide activation/deactivation method for multiple unified TCI states mapped to one TCI codepoint.

In some embodiments, RRC configures a list of joint DLorJoint TCI states, a list of UL TCI states. Alternatively, in some embodiments, RRC configures a list of joint TCI states, a list of DL TCI states, and a list of UL TCI states. Alternatively or in addition, in some embodiments, RRC configures the lists per BWP/CC/band or the lists per a group of BWPs/CCs/bands. Alternatively or in addition, in some embodiments, RRC configures the lists per TRP/CORESETPool/CORESET/search space set or the lists per a group of TRPs/CORESETs/search space sets.

In some embodiments, MAC CE includes the TCI state combination type corresponds to a TCI codepoint, based on UE capability reporting on which are the combination types that UE can support or whether a combination type that UE can support or not.

In some embodiments, the TCI state combination type may be one of: 1 indicated joint TCI state, 1 pair of indicated DL and UL TCI states, 1 indicated DL TCI state, 1 indicated UL TCI state, 1 indicated joint TCI state+1 indicated joint TCI state, 1 pair of indicated DL and UL TCI states+1 pair of indicated DL and UL TCI states, 1 pair of indicated DL and UL TCI states+1 indicated DL TCI state, 1 pair of indicated DL and UL TCI states+1 indicated UL TCI state, 1 indicated joint TCI state+1 pair of indicated DL and UL TCI states, 1 indicated joint TCI state+1 indicated DL TCI state, 1 indicated joint TCI state+1 indicated UL TCI state.

In some embodiments, alternatively, MAC CE includes the number of TCI states mapped to each TCI codepoint, and the candidate value may be at least {1.2.3.4}.

In some embodiments, in addition to the number of TCI states mapped to each TCI codepoint, the order of mapped TCI state type(s) is indicated. For example, a TCI codepoint has three TCI states, one of which is joint TCI state, one of which is DL TCI state, one of which is UL TCI state, and the order is DL, DL, and UL, or the order is joint, DL, UL.

In some embodiments, in addition, MAC CE may include at least one of the following information: TCI state [set] type: a joint TCI state or a pair of DL/UL TCI states, TCI state ID: a DL or joint TCI state ID or a UL TCI state ID, Serving cell ID where the TCI state is configured, DL/UL BWP ID where the TCI state is configured, Serving cell ID where the TCI state is applied, DL/UL BWP ID where the TCI state is applied.

In some embodiments, the terminal device 110 can determine the first plurality of TCI states based on a set of fields of the indication of at least one combination type. In some embodiments, the set of fields of the indication of at least one combination type may include a field indicating the number of TCI states for a TCI codepoint. For example, the field C_i is used to indicate the number of TCI states (or TCI state pairs) for the i-th codepoint.

In some embodiments, the set of fields of the indication of at least one combination type may also include a field indicating the type of each TCI state for the TCI codepoint. For example, the field P_i is used to indicate whether it is a joint TCI state or a pair of DL and UL TCI states for the 1st/2nd TCI state (TCI state pair) for the i-th codepoint.

In some embodiments, the set of fields of the indication of at least one combination type may also include a field indicating whether a TCI state is a downlink TCI state or an uplink TCI state in an octet. For example, the field D/U is used to indicate whether it is a DL TCI state (or DLorJoint TCI state) or a UL TCI state in the same oct.

In some embodiments, the set of fields of the indication of at least one combination type may also include a field indicating the number of TCI codepoints to be used. For example, the field “S” is used to indicate first N of C_i will be used (i.e., cannot be ignored).

In some embodiments, format of MAC CE (called format 1) includes the set of fields of the indication of at least one combination type above. The format 1 is described in detail below.

In some embodiments, the TCI state combination type information may indicate a TCI state combination type corresponding to a TCI codepoint. In possible format of MAC CE (called format 1),C_i, P_i or C_i and P_i are used to indicated TCI state combination type corresponding to a TCI codepoint.

In some embodiments, C_i indicates the number of TCI states (or TCI state pairs) for the i-th codepoint, e.g., whether 1 joint TCI state (or 1 pair of DL and UL TCI states) or 2 joint TCI states (or 2 pairs of DL and UL TCI states) are mapped to the i-th TCI codepoint, C_i=0 indicates the i-th codepoint indicates 1 TCI state (or 1 TCI state pairs), and P_(i,1) can be ignored. C_i=1 indicates the i-th codepoint indicates 2 TCI states (or 2 TCI state pairs), and P_(i,1) cannot be ignored.

In some embodiments, alternatively, C_i can be 2-bit, e.g., C_i,0 and C_i,1, C_i,0 is for the number of TCI state(s) for 1st TRP, or whether P_(i,0) can be ignored. C_i,1 is for the number of TCI state(s) for 2nd TRP, or whether P_(i,1) can be ignored.

In some embodiments, P_i (i.e. Pᵢ) indicates whether it is a joint TCI state or a pair of DL and UL TCI states for the 1st/2nd TCI state (TCI state pair) for the i-th codepoint. P_(i,0) indicates whether it is a joint TCI state or a pair of DL and UL TCI states for the first indicated TCI states (or TCI state pairs). Specially, P_(i,0)=0 indicates that both DL and UL TCI states are indicated, and two TCI state IDs include TCI state ID (i, 0, a) and TCI state ID (i, 0, b). P_(i,0)=lindicates that either DL or UL TCI state is indicated, and one TCI state ID includes TCI state ID (i, 0, a). Meanwhile, oct containing TCI state ID (i, 0, b) is not present. P_(i,1) indicates whether the it is a joint TCI state or a pair of DL and UL TCI states for the second indicated TCI states (or TCI state pairs). Specially, P_(i,1)=0 indicates that both DL and UL TCI states are indicated, and two TCI state IDs include TCI state ID (i, 1, a) and TCI state ID (i, 1, b). P_(i,1)=1 indicates that either DL or UL TCI state is indicated, and one TCI state ID includes TCI state ID (i, 1, a). Meanwhile, oct containing TCI state (i, 1, b) is not present.

In some embodiments, D/U indicates whether it is a DL TCI state (or DLorJoint TCI state) or a UL TCI state in the same oct. If D, TCI state ID refers to a DL TCI state or a DLorJoint TCI state, which is 7-bit length. If U, TCI state ID refer to an UL TCI state, which is 6-bit length and the most significant bit (MSB) is considered as reserved.

It should be noted that the TCI state ID can be indexed per TRP if per-TRP TCI state pool/list is configured and then may be less than 6-bit or 7-bit.

In some embodiments, in addition, “S” field which is M-bit (e.g., 3) long to indicated first N of C_i will be used (i.e., cannot be ignored).

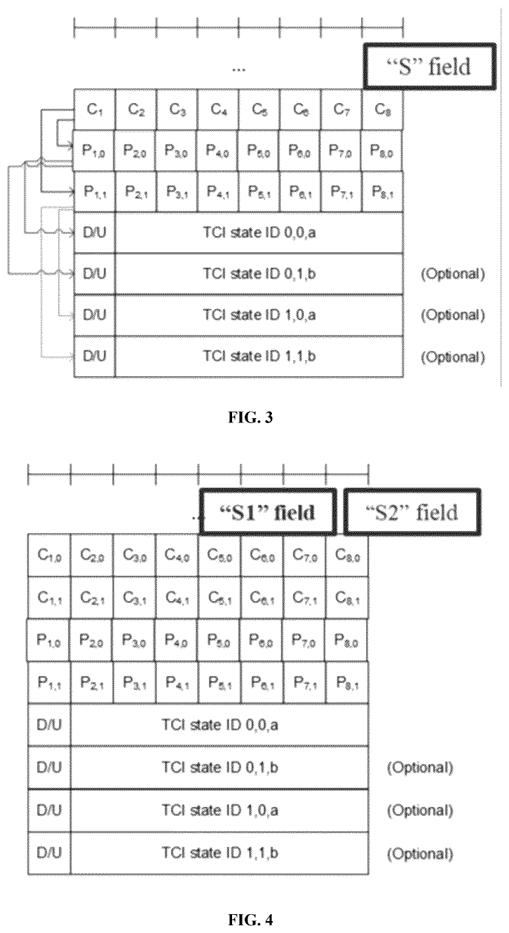

An exemplary format of MAC CE according to some embodiments of the present disclosure is shown in FIG. 3, as shown in FIG. 3, the format includes “S” field.

In some other embodiments, in addition, the number of “S” fields can be extended to 2 if C_i is 2-bit, e.g, “S1” for first N1 of C_i,0 and “S2” for first N2 of C_i,1.

An exemplary format of MAC CE according to other embodiments of the present disclosure is shown in FIG. 4, as shown in FIG. 4, the format includes “S1” and “S2” field.

It should be noted that the format 1 is used to map multiple TCI states (TCI state pairs) to one TCI codepoint, it is most useful in S-DCI MTRP mode where one DCI is used to indicate TCI states for multiple TRPs. It is most practical when multiple TRPs sharing an ideal backhaul. But, the format 1 may also be used in M-DCI MTRP mode.

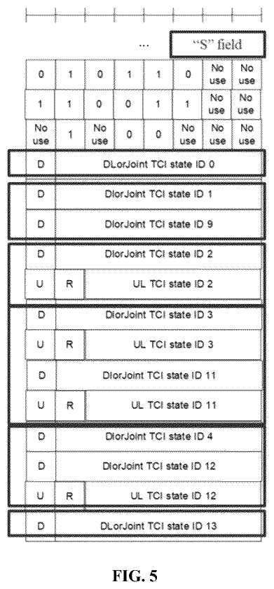

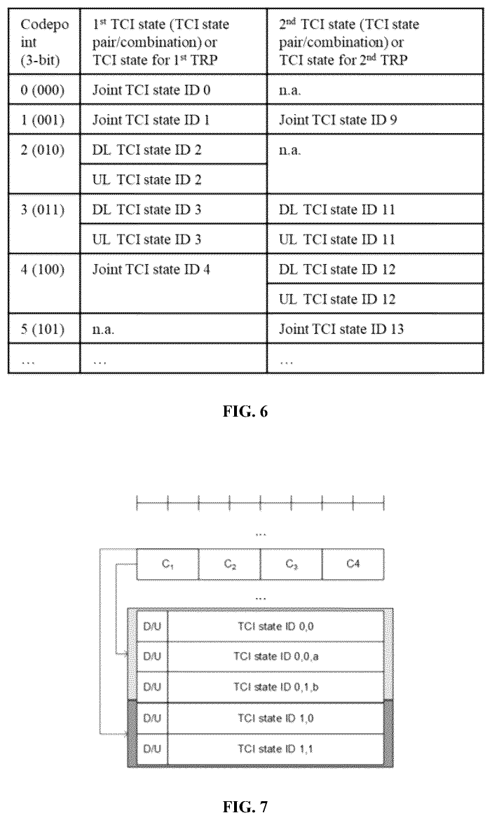

In some embodiments, using possible format 1 to indicate the following: first TCI codepoint: 1 joint TCI state; second TCI codepoint: 2 joint TCI states; third TCI codepoint: 1 pair of DL and UL TCI states; forth TCI codepoint: 2 pairs of DL and UL TCI states; fifth TCI codepoint: 1 joint TCI state and 1 pair of DL and UL TCI states; sixth TCI codepoint: 1 joint TCI state. An exemplary signalling format according to some embodiments of the present disclosure is shown in FIG. 5. based on the signalling as shown in FIG. 5, the schematic diagram of example interpretation of TCI states mapped to a codepoint shown in FIG. 6 can be obtained.

It should be noted that the example above assumes that 3-bit TCI field is used in DCI. The same method is readily extended to the case that TCI field is more or less than 3-bit. In addition, it should be noted that TCI field may consist of 3-bit codepoint as MSB/Least Significant Bit (LSB) and other additional bit(s). With reference to FIG. 5 and FIG. 6, in the example above, “S”=110 indicates first 6 C_i (C_0 to C_5) are useful.

In some embodiments, the TCI state combination type information may indicate the number of TCI states corresponding to a TCI codepoint. For example, the TCI state combination type information may indicate the number of TCI states corresponding to a TCI codepoint by using a field “C_i”. In some embodiments, in possible format of MAC CE (called format 2), C_i is used to indicated the number of TCI states corresponding to a TCI codepoint. For example. C_i indicates the number of TCI states. Specifically, C_i=0 means the i-th codepoint indicates 1 TCI state; C_i=1 means the i-th codepoint indicates 2 TCI states; C_i=2 means the i-th codepoint indicates 3 TCI states; C_i=3 means the i-th codepoint indicates 4 TCI states. For example C_1=2; C_2=1. It should be noted that C_i also can be written as Ci.

In some embodiments, in addition, if 3 TCI states associated with C_1 are D/D/U, then the first D is for TRP 1 as a joint TCI state, the followed D/U are for TRP 2 as separate DL/UL TCI states. In addition, if 3 TCI states associated with C_1 are D/U/D, then the first D/U is for TRP 1 as separate DL/UL TCI states, the followed D is for TRP 2 as a joint TCI state. In addition, if 3 TCI states associated with C_1 are D/U/U, then the first D/U is for TRP 1 as separate DL/UL TCI states, the followed D is for TRP 2 as a UL TCI state. In another example, if 4 TCI states associated with a C_i, then the order can be D/U/D/U by default. An exemplary relationship between C_i and TCI states is shown in FIG. 7.

In some embodiments, the field indicating the number of TCI states for the TCI codepoint may indicate the number of TCI states for each Transmit/Receive Point (TRP) of a plurality of TRPs. For example, in some alternative embodiments, C_i can be with an extra bit, e.g., 0 and 1. Specifically, C_i,0 is for the number of TCI state(s) for first TRP, C_i,1 is for the number of TCI state(s) for second TRP.

It should be noted that the format 2 is used to map multiple TCI states (TCI state pairs) to one TCI codepoint. it is most useful in S-DCI MTRP mode where one DCI is used to indicate TCI states for multiple TRPs. It is most practical when multiple TRPs sharing an ideal backhaul. But, the format may also be used in M-DCI MTRP mode.

In some embodiments, the set of fields of the indication of at least one combination type includes a field indicating a plurality of available combination types of TCI states corresponding to a TCI codepoint. For example, in some embodiments, the TCI state combination type information may indicate possible TCI state combination types corresponding to a TCI codepoint. In possible format of MAC CE (called format 3), the TCI state combination type information may indicate all the possible TCI state combination types corresponding to a TCI codepoint.

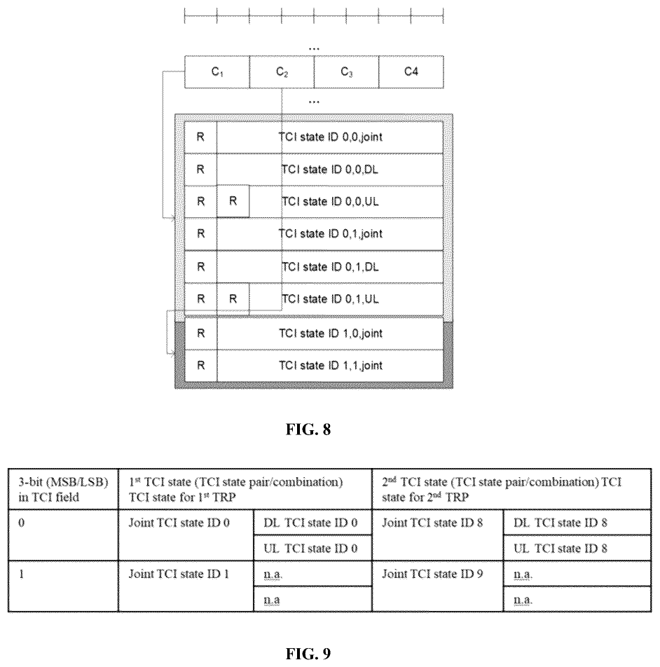

Exemplary relationship between C_i and TCI states is shown in FIG. 8. In some embodiments. C_i indicates possible TCI state combination types, for example, C_i=0 means the i-th codepoint may be used to all types of TCI state combinations, with reference to FIG. 8, when C_1=0, there are up to 6 possible TCI states (TCI state ID 0,0,joint; TCI state ID 0,0,DL; TCI state ID 0.0,UL; TCI state ID 0, 1,joint; TCI state ID 0,1,DL; TCI state ID 0,1,UL) mapped to one TCI codepoint, i.e. there are 6 TCI states corresponding to C₁ in FIG. 8. In some embodiments, C_i=1 means the i-th codepoint may be used to indicate one type of TCI state combination, e.g., 1 joint+1 joint, with reference to FIG. 8, when C_2=1, there are up to 2 possible TCI states mapped to one TCI codepoint, i.e. there are 2 TCI states (TCI state ID 1,0,joint+TCI state ID 1,1,joint) are corresponding to C₂ in FIG. 8. In some embodiments, there are other possible types: e.g., two of TCI state combination types, three of TCI state combinations types, etc. It should be noted that the format 3 is used to map multiple TCI states (TCI state pairs) to one TCI codepoint, it is most useful in S-DCI MTRP mode where one DCI is used to indicate TCI states for multiple TRPs. It is most practical when multiple TRPs sharing an ideal backhaul. But, the format 3 may also be used in M-DCI MTRP mode. In some embodiments, all possible combinations of TCI states mapping to a TCI codepoint can be signaled via e.g., MAC CE. An example of combinations of TCI states mapping to a TCI codepoint via MAC CE are shown in FIG. 9.

In some embodiments, set of fields of the indication of at least one combination type. and wherein the set of fields may include: a field indicating whether each TCI codepoint has a plurality of TCI states or a TCI state; a field indicating whether a TCI state ID in the same octet is for a type of TCI state; a field indicating identity of Transmit/Receive Point (TRP) or Control Resource Set (CORESET) pool; and a field indicating identity of the TCI state.

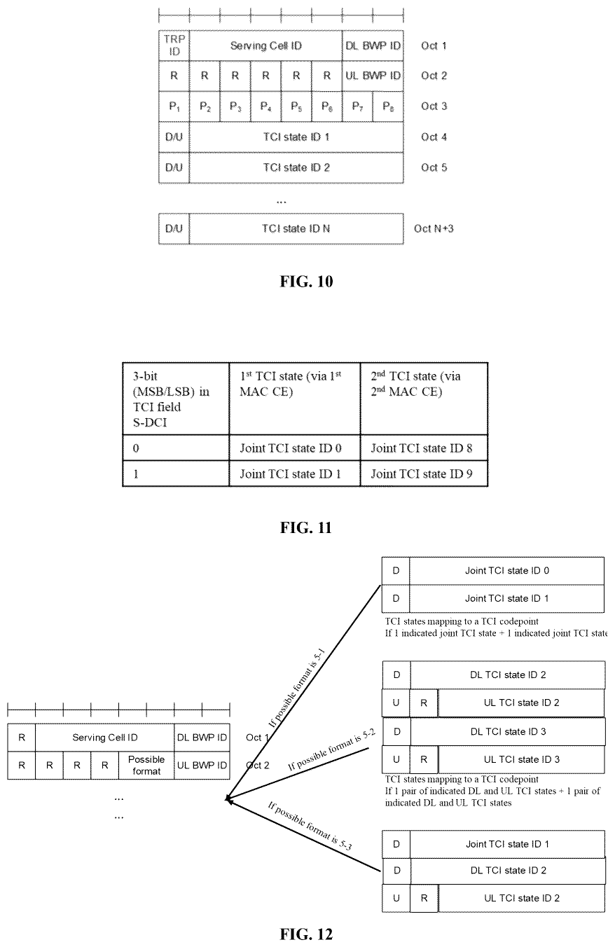

For example, in possible format of MAC CE (called format 4) of some embodiments, the field Pᵢ indicates whether each TCI codepoint has multiple TCI states or single TCI state. If Pᵢ field set to 1, it indicates that i^{th} TCI codepoint includes the DL TCI state and the UL TCI state. If Pᵢ field set to 0. it indicates that i^{th} TCI codepoint includes only the DL TCI state or the UL TCI state. The field D/U indicates whether the TCI state ID (i.e. identity of the TCI state) in the same octet is for joint/downlink or uplink TCI state, if this field is set to 1, the TCI state ID in the same octet is for joint/downlink, and if this field is set to 0, the TCI state ID in the same octet is for uplink. The field TRP ID (i.e. identity of TRP), or CORESET Pool ID indicates that mapping between the activated TCI states and the codepoint of the DCI Transmission Configuration Indication (TCI) set by field Ti is specific to the TRP configured with TRP ID or the ControlResourceSetld configured with CORESET Pool ID. This field set to 1 indicates that this MAC CE shall be applied for the DL transmission scheduled by the first TRP or CORESET with the CORESET pool ID equal to 1, otherwise, this MAC CE shall be applied for the DL transmission scheduled by the second TRP or CORESET pool ID equal to 0. If the coresetPoolIndex is not configured for any CORESET, MAC entity shall ignore the CORESET Pool ID field in this MAC CE when receiving the MAC CE. If the Serving Cell in the MAC CE is configured in a cell list that contains more than one Serving Cell, the CORSET Pool ID field shall be ignored when receiving the MAC CE. TCI state ID may be further indexed per TRP ID. Exemplary MAC CE format is shown in FIG. 10.

It should be noted that the format 4 is used to map multiple TCI states to one TCI codepoint for one TRP, it is most useful in M-DCI MTRP mode where two DCIs are used to indicate TCI state for each TRP. Two MAC CEs are needed. In addition, it may also be used for S-DCI MTRP mode too. Two MAC CEs each indicates TCI state for a specific TCI codepoint and TCI field in DCI points to two different TCI states indicated separately. An example of combinations of TCI states mapping to a TCI codepoint via MAC CE are shown in FIG. 11, TCI states mapping to a TCI codepoint via two MAC CEs.

In some embodiments, the terminal device 110 may determine a plurality of available Media Access Control Control Element (MAC CE) formats based on the indication of at least one combination type. the MAC CE formats including combination of at least two TCI states. For example, in some embodiments, there are multiple possible MAC CE formats based on configuration/indication of TCI state combination type. Exemplary MAC CE formats are shown in FIG. 12, as an example, possible format 5-1 may be 1 joint+1 joint. Possible format 5-2 may be 1 pair+1 pair. Possible format 5-3 may be 1 joint+1 pair. Possible format 5-4 may be 1 pair+1 joint (not shown). Joint in possible format above is a type of unified TCI states, and pair means an UL TCI state and a DL TCI state.

In some embodiments, in addition, a bit or a field can be reserved in MAC CE to indicate the possible format applied.

In some embodiment, the TCI state combination type mapped to a TCI codepoint is determined by default without explicit configuration or indication.

The following is a detailed introduction to the indication of at least one update type. The terminal device 110 may update the first plurality of TCI states based on the at least one update type to obtain a second plurality of TCI states. In some embodiments, the terminal device 110 may update at least one of the first plurality of TCI states based on a first information of the indication of at least one update type, the first information indicating the TCI state corresponding to an indicated TCI codepoint in Downlink Control Information (DCI) to be updated.

Alternatively or additionally, in some embodiments, the terminal device 110 may update, based on a second information of the indication of at least one update type, the TCI states of the first plurality of TCI states for same Transmit/Receive Points (TRPs), different TRPs, or a plurality of TRPs.

Alternatively or additionally, in some embodiments, the terminal device 110 may update at least part of the TCI states of the first plurality of TCI states based on a third information of the indication of at least one update type.

Alternatively or additionally, in some embodiments, the terminal device 110 may update one type of TCI state of the first plurality of TCI states based on a fourth information of the indication of at least one update type.

Alternatively or additionally, in some embodiments, the terminal device 110 may update the TCI states of the first plurality of TCI states associated with same Physical Cell Identifier (PCI) or different PCIs based on a fifth information of the indication of at least one update type.

In some embodiments, for example, TCI state indication contains TCI states update type, including at least one of the following information: first information: update 1st/2nd/all TCI states corresponds to the indicated TCI codepoint in DCI; second information: update TCI state for the same/different/all TRPs; third information: update all TCI states; update part of TCI states; forth information: update joint TCI state; update DL TCI state; update UL TCI state; update the pair of DL and UL TCI states. The TCI state indication including TCI states update type is an example of an indication of at least one update type. In this way, the terminal device 110 can update part of TCI states when needed.

In some embodiments, for example, the TCI states update type can be indicated via one or many of the following information: first information, second information, third information, and forth information. The first information is used for updating 1st TCI state corresponds to the indicated TCI codepoint in DCI and updating 2nd TCI state corresponds to the indicated TCI codepoint in DCI, in addition, the first information can be used for updating all TCI states corresponds to the indicated TCI codepoint in DCI. The second information is used for updating TCI state for the same TRP or updating TCI state for a different TRP, in addition, the second information can be used for updating TCI states for all TRPs. In other words, the second information can be used for updating TCI states associated with the same CORESETPoolIndex, update TCI states associated with different CORESETPoolIndex. Third information is used for updating all TCI states, or updating part of TCI states. It should be noted that the third information may be merged into first information or the second information in some embodiments. Forth information can be used for updating joint TCI state, DL TCI state, UL TCI state or the pair of DL and UL TCI states, in other words, the forth information can be used for updating a certain TCI state type of a certain TCI state combination type, joint TCI state, DL TCI state, UL TCI state or the pair of DL and UL TCI states are examples of TCI state types. In some embodiments, in addition, other information such as information for updating TCI states associated with the same PCI, information for updating TCI states associated with different PCI, and so on, the information may be a fifth information of the indication of at least one update type.

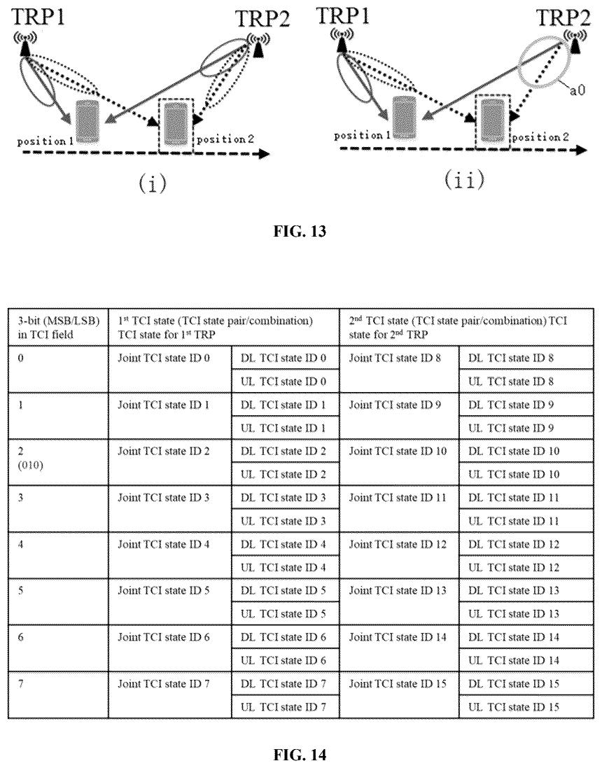

Based on the method of present disclosure, in some scenarios, update one of the multiple beams flexible can be realized. An exemplary scenario of update at least one of the multiple beams is shown in FIG. 13 (includes (i) and (ii)), the solid line corresponds to using beams from the two TRP (TRP1 and TRP2) at position 1, and the dashed line corresponds to using the beams from the two TRP (TRP1 and TRP2) at position 2, and solid or dashed circles indicate beam coverage, for example, the solid or dashed circle indicate a corresponding beam is narrow or wide. As shown in FIG. 13 (i). from the position 1 to position 2, there are two beams need to be updated, in other words, it is need to update beams per TRP, for example, to update two joint TCI states or update two DL TCI states. As shown in FIG. 13 (ii), from the position 1 to position 2, there is one beam need to be updated. As shown at a0. the beam is wide and there is no need to change, in other words, update beam for TRP1 and keep using the same beam for TPR2, for example, update one joint TCI states and keep using one joint TCI state. or update one DL TCI state and keep using one DL TCI state.

An example of all possible combinations the TCI states mapping to a TCI codepoint are shown in FIG. 14, in some embodiments, TCI states mapping to a TCI codepoint with all possible combinations, can be signaled via e.g., MAC CE. With reference to FIG. 14, the following are some examples to illustrate same 3-bit TCI field may result in different TCI state update behaviours, in example 1, the first information indicates updating 1st TCI state, and TCI field (3-bit) is 010, the results is updating 1st TCI state to joint TCI state ID 2, and 2nd TCI state staying unchanged. In example 2, the first information indicates updating 2nd TCI state, and TCI field (3-bit) is 010, the results is updating 2nd TCI state to joint TCI state ID 10, and 1st TCI state staying unchanged. In example 3, the first/third information indicates updating both TCI states, and TCI field (3-bit) is 010, the results is updating 1st TCI state to joint TCI state ID 2, and updating 2nd TCI state to joint TCI state ID 10. In example 4, the third information indicates updating part of TCI states, and the forth information indicates updating UL TCI state, and TCI field (3-bit) is 010, the results is updating 1st TCI state to UL TCI state ID 2, and updating 2nd TCI state to UL TCI state ID 10.

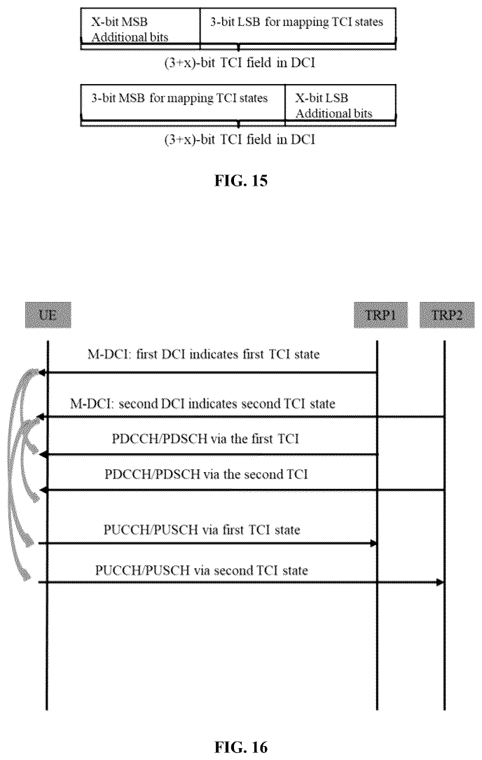

In some embodiments, the first/second/third/forth/fifth information can be explicitly indicated. Alt 1 is via RRC configuration or MAC CE indication, for example, via MTRP mode indication or TCI state update type indication. Alt 2 is via adding additional bit(s) in a TCI field, FIG. 15 is a schematic diagram of information the first/second/third/fourth be explicitly indicated via adding additional bit(s) in a TCI field. As shown in FIG. 15, e.g., TCI field is (3+x)-bit, in which x is the bit(s) for first information and 3-bit MSB or LSB is for mapping TCI states. Alt 3 is via adding additional field, e.g., keep 3-bit TCI field, and introduce a 2-bit TCI state update type field. As an example, the TCI state update type indication may be transmitted from a base station to a UE via a DCI.

In some embodiments, the first/second/third/forth information can be implicitly indicated. Alt 1 is via re-interpretation of other DCI field, for example, “MTRP mode indication” field in DCI if any. Alt 2 is via setting special value for other DCI field. If the DCI is without DL assignment, the other fields set as all “0” indicate updating the first TCI states. The other fields set as all “1” indicate updating all TCI states. In some other embodiments, if the DCI is without DL assignment, the other fields set as all “0” indicate updating the TCI states for the same TRP, and the other fields set as all “1” indicate updating TCI states for all TRPs.

The TCI state update types that UE can support can be determined based on UE capability reporting. For example, the UE capability may be reported by a UE to a base station via UE capability reporting.

In some embodiments, the TCI state update type is determined by default without explicit configuration or indication. For example. the default TCI state update type is to update all TCI states mapped to the TCI codepoint.

FIG. 16 is schematic diagram of communication between the terminal device 110 with multiple TRPs in accordance with some embodiments of the present disclosure, as shown in FIG. 16, take two TRPs for example. and the terminal device 110 may be UE. A first TRP (TRP1) may transmit a first DCI indicating a first TCI state to UE, and a second TRP (TRP2) may transmit a second DCI indicating a second TCI state to UE. UE may receive PDCCH/PDSCH via the first TCI state from TRP1, and UE may receive PDCCH/PDSCH via the second TCI state from TRP2. The UE may transmit PUCCH/PUSCH via the first TCI state to TRP1, and transmit PUCCH/PUSCH via the second TCI state to TRP2.

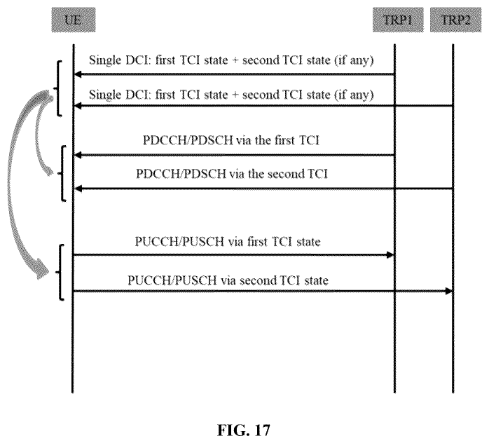

FIG. 17 is schematic diagram of communication between the terminal device 110 with multiple TRPs in accordance with some other embodiments of the present disclosure, as shown in FIG. 17. take two TRPs for example, and the terminal device 110 may be UE. A first TRP (TRP1) may transmit a single DCI indicating a first TCI state and a second TCI state (if any) to UE. and a second TRP (TRP2) may transmit a single DCI indicating a first TCI state and a second TCI state (if any) to UE. UE may receive PDCCH/PDSCH via the first TCI state from TRP1, and UE may receive PDCCH/PDSCH via the second TCI state from TRP2. The UE may transmit PUCCH/PUSCH via the first TCI state to TRP1, and transmit PUCCH/PUSCH via the second TCI state to TRP2.

In some embodiments, the terminal device 110 may transmit, to the network device 120, the capability information of the terminal device 110, accordingly, the network device 120 may receive, from the terminal device 110, the capability information of the terminal device 110.

In some embodiments. the capability information of the terminal device 110 is second capability information, and may be used by the network device 120 for configuring the first plurality of TCI states, in other words, the capability information of the terminal device 110 may be used by the network device 120 for determining the indication of at least one combination type.

Alternatively or additionally, in some embodiments, the capability information of the terminal device 110 is first capability information, and may be used by the network device 120 for determining the indication of at least one update type.

In some embodiments, the capability information of the terminal device 110 comprises the information of the capability on whether the terminal device 110 supports Simultancous Transmission from Multiple Panels (STxMP) transmission mode.

Alternatively or additionally, in some embodiments, the capability information of the terminal device 110 comprises the information of the capability on whether the terminal device 110 support both joint TCI states and separated TCI states.

In some embodiments, multiple TCI states can be mapped to a TCI codepoint depending on UE capability and TA configuration. In some embodiments, at least one of the following constraints can be considered: UE capability on whether UE can support STxMP transmission modes. UE capability on whether UE can support both joint TCI state or separated DL/UL TCI states, and TA values.

In some embodiments, for UE capability on whether UE can support STxMP transmission modes, if the UE cannot support STxMP transmission modes, then the UE does not expect to be configured/activated TCI state combination types corresponding to the a TCI codepoint containing more than 2 simultaneous UL TCI states, for example, the UE does not expect to be configured/activated TCI state combination types as below: 1 indicated joint TCI state+1 indicated joint TCI state; 1 pair of indicated DL and UL TCI states+1 pair of indicated DL and UL TCI states; 1 pair of indicated DL and UL TCI states+1 indicated UL TCI state; 1 indicated joint TCI state+1 pair of indicated DL and UL TCI states; 1 indicated joint TCI state+1 indicated UL TCI state.

In some embodiments, for UE capability on whether UE can support both joint TCI state or separated DL/UL TCI states, if the UE cannot support multiple TCI state types, then the UE does not expect to be configured/activated TCI state combination types corresponding to the a TCI codepoint containing more than 1 TCI state types, for example, the UE does not expect to be configured/activated TCI state combination types as below: 1 indicated joint TCI state+1 pair of indicated DL and UL TCI states; 1 indicated joint TCI state+1 indicated DL TCI state; 1 indicated joint TCI state+1 indicated UL TCI state.

In some embodiments, if multiple TA values are associated with UL transmissions, which may be realized by one of the following: multiple TAs are configured within one TAG; multiple TAGs (or TAG IDs) arc configured for a cell; multiple n-TimingAdvanceOffset value are configured for a cell; multiple DL reception reference timings are considered.

In some embodiments, for UE not support STxMP, the transmit timing to two TRPs may need an additional gap. UE does not expect to be configured/activated TCI state combination types corresponding to the a TCI codepoint containing more than 2 simultaneous UL TCI states or 2 UL TCI states associated with UL transmissions within a specific gap. For UE support STxMP. the transmit timing to two TRPs may need to be aligned, and UE expects at least one of TA values are the same for the two TRPs if the two TRPs are associated with different PCIs.

Alternatively or additionally, in some embodiments, the capability information of the terminal device 110 comprises the information of the number of TCI state combinations can be configured and activated per BWP/CC and across BWP/CC respectively. In some embodiments, the capability information of the terminal device 110 comprises the information of the number of different PCIs can be updated in one indicated combination of TCI states. For UE supporting only 1 different PCI can be updated, the PCIs for the newly indicated TCI state combination are at least partially same as the old TCI state combination, for example, the old TCI state combination consists of TCI state ID 1 with PCI 1 and TCI state ID 2 with PCI 2 and the newly indicated TCI state combinations consists of TCI state ID 3 with PCI 1 and TCI state ID 4 with PCI 3 where at least PCI 1 is maintained. For UE supporting two different PCIs can be updated, the PCIs of the newly indicated TCI state combination are different from the old TCI state combinations, for example. the old TCI state combination consists of TCI state ID 1 with PCI 1 and TCI state ID 2 with PCI 2 and the newly indicated TCI state combinations consists of TCI state ID 5 with PCI 3 and TCI state ID 4 with PCI 3 whether PCI 1 and PCI 2 are both not maintained and updated to PCI 3 and PCI 4.

In some embodiments, methods for mapping multiple TCI states to a TCI codepoint can be a form of RRC signalling, i.e., the TCI state combination type used in MAC CE. MAC CE format can be determined based on the indicated mapping method. In this way, the complexity of TCI state activation/activation can be reduced.

In some embodiments, RRC configures the TCI state combination type can be used. for example, 1 indicated joint TCI state+1 indicated joint TCI state, or 1 pair of indicated DL and UL TCI states+1 pair of indicated DL and UL TCI states, or 1 indicated joint TCI state+1 pair of indicated DL and UL TCI states.
MIMOParam-r18::=SEQUENCE {
. . .
unifiedTCI-State-Combination-Type-r18 ENUMERATED {separate, joint, both}

unifiedTCI-State-Combination-Type: indicates the unified TCI state combination type the UE is configured for this serving cell. The value “separate” means this serving cell is configured with dl-orJoint-TCI-ToAddModList for DL TCI state and ul-TCI-ToAddModList for UL TCI state and the combination is 1 separate+1 separate (or 1 pair+1 pair). The value “joint” means this serving cell is configured with dl-orJoint-TCI-ToAddModList for joint TCI state for UL and DL operation and TCI state combination type is 1 joint+1 joint. The value “both” means the combination type is 1 joint+1 separate (or 1 joint+1 pair).

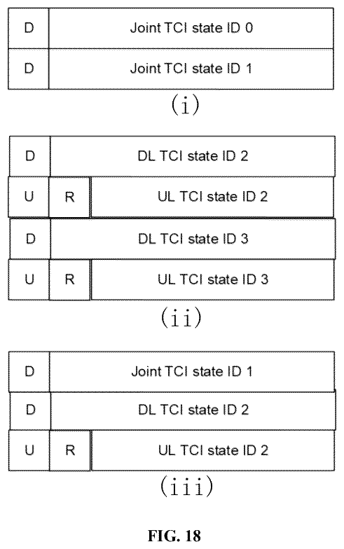

FIG. 18 is schematic diagram of some MAC CE formats of the TCI states mapping to a TCI codepoint. As shown in FIG. 18, UE expects the MAC CE format accordingly, based on the examples as below:

For TCI states mapping to a TCI codepoint, if the TCI state combination type is 1 indicated joint TCI state+1 indicated joint TCI state, then there are 2 TCI states mapped to a codepoint, and 2 oct is used in MAC CE (as shown in FIG. 18(i)). If the TCI state combination type is 1 pair of indicated DL and UL TCI states+1 pair of indicated DL and UL TCI states, then there are 4 TCI states mapped to a codepoint, and 4 oct is used in MAC CE (as shown in FIG. 18(ii)). If the TCI state combination type is 1 indicated joint TCI state+1 pair of indicated DL and UL TCI states, then there are 3 TCI states mapped to a codepoint, and 3 oct used in MAC CE (as shown in FIG. 18(iii)).

In some embodiments, alternatively, fields C_i and P_i introduced above can be used in the MAC CE format.

In some embodiments, if a UE is provided a single TCI state combination, or if the UE receives a MAC CE activation command for one combinations of TCI states, the UE assumes that the DM-RS antenna port associated with PDCCH/PDSCH is quasi co-located with the one or more RS configured by the TCI states. In addition, the UE assumes that PUCCH/PUSCH Tx beam and power control parameters are associated with one or more RS configured by the TCI statcs.

In some embodiments, if a UE has been provided a configuration of more than one TCI states combinations but has not received a MAC CE activation command for one of the TCI state combinations, a default UE behaviour can be defined, for example, the UE assumes that the DM-RS antenna port associated with PDCCH/PDSCH receptions is quasi co-located with the a sct of SS/PBCH block(s) or the CSI-RS resource(s) the UE identificd during the initial access procedure, during the random access procedure initiated by the reconfiguration with sync procedure, or for a most recent configured grant PUSCH transmission for a same HARQ process. In addition, the UE assumes that PUCCH/PUSCH Tx beam and power control parameters are associated with the set of SS/PBCH block(s) or the CSI-RS resource(s).

In some embodiments, for the TCI state combination type set to “1 joint TCI state+1 joint TCI state”, if a UE is provided two joint TCI states (e.g., via RRC), or if the UE receives a MAC CE activation command for two of the joint TCI states, the UE assumes that the DM-RS antenna port associated with PDCCH/PDSCH is quasi co-located with the two DL RS configured by the TCI states. In addition, the UE assumes that PUCCH/PUSCH Tx beam and power control parameters are associated the two indicated joint TCI states. If more than two joint TCI states are provided but UE has not received a MAC CE activation for two joint TCI states, the default UE behaviour may be applied. for example, UE may assume that PDCCH/PDSCH reception is QCLed with two SS/PBCH block or two CSI-RS resource the UE identified during the initial access procedure, during the random access procedure initiated by the reconfiguration with sync procedure, or for a most recent configured grant PUSCH transmission for a same HARQ process.

In some embodiments, for the TCI state combination type set to “1 pair of DL/UL TCI states+1 pair of joint DL/UL TCI states”, if a UE is provided two DL TCI states and two UL TCI states (e.g., via RRC). or if the UE receives a MAC CE activation command for two pairs of DL and UL TCI states, the UE assumes that the DM-RS antenna port associated with PDCCH/PDSCH is quasi co-located with the two DL RS configured by the DL TCI states. In addition, the UE assumes that PUCCH/PUSCH Tx beam and power control parameters are associated the two indicated UL TCI states. If more than two DL TCI states and/or more that two UL TCI states are provided but UE has not received a MAC CE activation for two DL TCI states and two UL TCI states, the default UE behaviour may be applied.

According to the embodiments introduced above, the network device 120 transmits the indication of one or both of TCI state combination type and TCI state update type, for example, TCI state combination type (contained in MAC CE) for multiple TCI states mapped to one TCI codepoint, and constraints based on UE capability, in some embodiments, TCI state combination type and TCI state update type can be transmitted in separate indication. in addition, TCI states update type indication can be used for updating one or many of indicated TCI states, and update TCI states for other TRPs/cells is realized, thus the problem that existing 3-bit TCI field is quite limited to signal TCI state combinations for MTRP, and there is not flexible method to update TCI state for one of TRPs if multiple TCI states mapped to one TCI codepoint in DCI is solved.

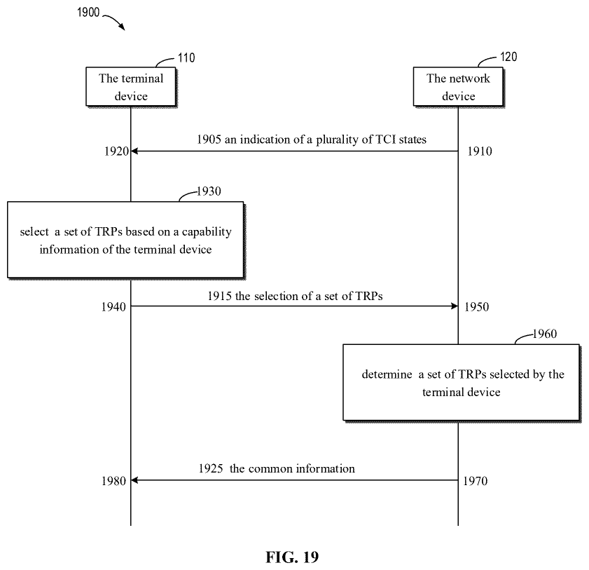

FIG. 19 illustrates schematic diagram of communication between the terminal device 110 and the network device 120 in accordance with some other embodiments of the present disclosure. As shown in FIG. 19, in method 1900, the network device 120 may transmit (1910), to a terminal device 110, an indication of a plurality of TCI states (1905) associated with Transmit/Receive Points (TRPs) with different PCIs, accordingly, the terminal device 110 may receive (1920), from a network device 120, the indication of a plurality of TCI states associated with Transmit/Receive Points (TRPs) with different Physical Cell Identifiers (PCIs). The terminal device 110 may select (1930) a set of TRPs based on a capability information of the terminal device 110. The terminal device 110 transmit (1940) the selection (1915) of a set of TRPs to the network device 120. Accordingly, the network device 120 may receive (1950) the selection. The network device 120 may determine (1960) a set of TRPs selected by the terminal device 110. The network device 120 may transmit (1970), to the terminal device 110, the common information (1925) from the set of TRPs. Accordingly, the terminal device 110 may receive (1980) from the set of TRPs, a common information of a plurality of terminal devices 110.

Since UE is not required to monitor SI/paging/short message from two cells with different PCIs according to Rel-17 discussion between RAN1 and RAN2. In Rel-17, only 1 unified TCI state is indicated, therefore it is either the serving cell TRP or the TRP with different PCI. If more than 1 unified TCI states are indicated in Rel-18, it is possible that they are associated with both serving cell TRP and the TRP with different PCI simultaneously. However, according to the embodiments above, the problem that whether/how UE receive short massage and system information from more than one cell is solved.

In some embodiments, in order to select the set of TRPs, the terminal device 110 may base on the capability information, select serving cell TRP or a TRP with a different PCI from the serving cell TRP based on one of: TCI state ID, CORESET ID or configuration of CORESET 0.

In some embodiments, in order to select the set of TRPs, the terminal device 110 may basc on the capability information, selecting serving cell TRP or a TRP with a different PCI from the serving cell TRP based on one of: quality of receiving signal of the terminal device 110, trajectory of the terminal device 110, or higher layer indication or procedure.

In some embodiments, the common information may be one of: short message, system information, common Physical Downlink Control Channel (PDCCH), common Physical Downlink Shared Channel (PDSCH), or Common Search Space (CSS), or Synchronization Signal Block (SSB).

According to some embodiments of the present disclosure, UE can receive short message and system information from TRPs associated with different PCIs by depending on UE capability and in use of possible selection methods provided by the present disclosure. In this way, the common information can be correctly received by the terminal devicc 110.

In some embodiments, UE can receive short message and system information always from serving cell TRP or TRP with different PCI. In some embodiments, UE can receive short message and system information from both TRPs.

In some embodiments, for the UE does not expect different information, the capability of UE supports receiving the same common information from different TRPs. The network device 120 can constraint that transmitting the same common information to the UE from serving cell TRP and TRP with different PCI. In some embodiments, UE expects the same PDCCH for a Type0/0A/1/2-PDCCH CSS set when active TCI states for a corresponding CORESET are not associated with the same PCI.

In some embodiments. for UE can handle both PCIs, e.g., the UE capability reporting on whether it can receive short message and system information for TRPs with different PCIs can be transmitted to the network device 120. The network device 120 may transmit different common information from serving cell TRP and TRP with different PCI. In some embodiments, UE monitors PDCCH candidates for a Type0/0A/1/2-PDCCH CSS set when active TCI states for a corresponding CORESET are not associated with the same PCI.

In some embodiments, UE capability can support the UE to receive short message and system information from one cell. UE may perform selection between serving cell TRP and TRP with different PCI, and the selection by using one of the following: TCI state ID, for example, select the one of TRPs with lower or higher TCI state ID; CORESET ID, for example, select the one of TRPs with lower or higher CORESET ID: CORESET 0, for example, CORESET 0 is associated with serving cell TRP or TRP with different PCI. In some embodiments. UE monitors PDCCH candidates for a Type0/0A/1/2-PDCCH CSS set applying the active TCI state for a corresponding CORESET associated with the selected TRP.

In some embodiments, based on UE selection, additional UE report may be needed to inform the network which configuration is applied from this UE's perspective.

In some embodiments, UE selection may be based on receive signal quality: for example, which TRP has a higher received power or have an increased received power based on historical measurements.

In some embodiments, UE selection may be based on UE trajectory, for example, moving towards a TRP with different PCI.

In some embodiments, UE selection may be based on higher layer indication or higher layer procedure.

It should be noted that the methods discussed above can also be extend to whether/how UE receive common channels (like common PDCCH/PDSCH, CSS) and common signals (like SSB).

In some embodiments, if a UE monitors the PDCCH candidate for a Type0-PDCCH CSS set (or a Type0A/1/2-PDCCH CSS set) on the serving cell (e.g., from serving cell TRP) and/or on cell with different PCI (e.g., from TRP with different PCI), the UE may assume that no SS/PBCH block is transmitted in REs used for monitoring the PDCCH candidate on the serving cell and/or on the cell with different PCI.

In some embodiments, if at least one RE of a PDCCH candidate for a UE on the serving cell and/or on the cell with different PCI overlaps with at least one RE of lte-CRS-ToMatchAround, or of LTE-CRS-PatternList, (or LTE CRS with serving cell and/or cell with different PCI) the UE is not required to monitor the PDCCH candidate on the serving cell and/or on the cell with different PCI.

In some embodiments, if a UE is provided available RB-SetsPerCell, (or available RB sets of the serving cell and/or cell with different PCI), the UE is not required to monitor PDCCH candidates on the serving cell and/or on cell with different PCI that overlap with any RB from RB sets that are indicated as unavailable for receptions by an available RB set indicator.

In some embodiments, for a CORESET with index 0 or common PDCCH/PDSCH, the UE expects that a CSI-RS configured with qcl-Type set to ‘typeD’ in a TCI state is provided by a SS/PBCH block from the serving cell or the cell with different PCI.

According to the embodiments of the present disclosure, the network device 120 may transmit a TCI state combination type indication to the terminal device 110, for example, TCI state activation/deactivation signalling contains at least TCI state combination type information, which indicates: a TCI state combination type corresponding to a TCI codepoint; the number of TCI states corresponding to a TCI codepoint; possible TCI state combination types corresponding to a TCI codepoint; 4 different MAC CE formats introduced in the embodiments as above. In some embodiments, there exist constraints based on UE capabilities and TA configurations. In some embodiments, separatc signaling on TCI state combination type is used. In some embodiments, UE capability of support which TCI state combination types and which MAC CE formats is considered. In addition, TCI state indication may contain TCI states update type, including at least one of the following information: first information for updating 1st/2nd/all TCI states corresponds to the indicated TCI codepoint in DCI; second information for updating TCI state for the same/different/all TRPs; third information for updating all TCI states or part of TCI states; forth information for updating joint TCI state, DL TCI state, UL TCI state or the pair of DL and UL TCI states. In some embodiments, UE capability of support which TCI state update types and which DCI formats is considered. In this way, the problem that existing 3-bit TCI field is quite limited to signal TCI state combinations for MTRP, and there is not flexible method to update TCI state for one of TRPs if multiple TCI states mapped to one TCI codepoint in DCI is solved.

According to the other embodiments of the present disclosure, the terminal device 110. for example UE, can receive short message and system information from TRPs associated with different PCIs, and the related UE capabilities is considered, in addition, selection methods is provided. In this way, the problem that whether/how UE receive short massage and system information from more than one cell is solved.

In summary, embodiments of the present disclosure may provide the following solutions.

A method of communication, comprises: receiving, at a terminal device from a network device, an indication of at least one update type for updating a first plurality of transmission configuration indication (TCI) states, the indication of at least one update type being determined based on first capability information of the terminal device; updating the first plurality of TCI states based on the at least one update type to obtain a second plurality of TCI states; and communicating with the network device based on the second plurality of TCI states.

In one embodiment, the method as above, wherein updating the first plurality of TCI states comprises one of: updating at least one of the first plurality of TCI states based on a first information of the indication of at least one update type, the first information indicating the TCI state corresponding to a indicated TCI codepoint in Downlink Control Information (DCI) to be updated; updating, based on a second information of the indication of at least one update type, the TCI states of the first plurality of TCI states for same Transmit/Receive Points (TRPs), different TRPs, or a plurality of TRPs; updating at least part of the TCI states of the first plurality of TCI states based on a third information of the indication of at least one update type; updating one type of TCI state of the first plurality of TCI states based on a fourth information of the indication of at least one update type; updating the TCI states of the first plurality of TCI states associated with same Physical Cell Identifier (PCI) or different PCIs based on a fifth information of the indication of at least one update type.

In one embodiment, the method as above further comprises: receiving, at the terminal device from the network device, an indication of at least one combination type for determining the first plurality of TCI states, the indication of at least one combination type being determined based on second capability information of the terminal device.

In one embodiment, the method as above, wherein determining the first plurality of TCI states based on a set of fields of the indication of at least one combination type. and wherein the set of fields includes: a field indicating the number of TCI states for a TCI codepoint; a field indicating the type of each TCI state for the TCI codepoint; a field indicating whether a TCI state is a downlink TCI state or an uplink TCI state in an octet; and a field indicating the number of TCI codepoints to be used.

In one embodiment, the method as above, wherein the field indicating the number of TCI states for the TCI codepoint indicates the number of TCI states for each Transmit/Receive Point (TRP) of a plurality of TRPs.

In one embodiment, the method as above, wherein determining the first plurality of TCI states based on a set of fields of the indication of at least one combination type, and wherein the set of fields includes a field indicating a plurality of available combination types of TCI states corresponding to a TCI codepoint.

In one embodiment, the method as above, wherein determining the first plurality of TCI states based on a set of fields of the indication of at least one combination type, and wherein the set of fields includes: a field indicating whether each TCI codepoint has a plurality of TCI states or a TCI state; a field indicating whether a TCI state ID in the same octet is for a type of TCI state; a field indicating identity of Transmit/Receive Point (TRP) or Control Resource Set (CORESET) pool; and a field indicating identity of the TCI state.

In one embodiment, the method as above further comprises: determining a plurality of available Media Access Control Control Element (MAC CE) formats based on the indication of at least one combination type, the MAC CE formats including combination of at least two TCI states.

In one embodiment, the method as above further comprises: transmitting, to the network device, the capability information of the terminal device, the capability information of the terminal device being used for configuring the first plurality of TCI states, and the capability information of the terminal device comprises at least one of: the information of the capability on whether the terminal device support Simultaneous Transmission from Multiple Panels (STxMP) transmission mode; and the information of the capability on whether the terminal device support both joint TCI states and separated TCI states.

In one embodiment, the method as above, wherein: receiving the indication of at least one update type via one of: Radio Resource Control (RRC) signaling or Media Access Control Control Element (MAC CE); additional bits in a TCI field; or additional field different from a predefined TCI field.

In one embodiment, the method as above, wherein: receiving the indication of at least one update type via one of: a field by re-interpretating a Downlink Control Information (DCI) field; or special value set for a DCI field.

In one embodiment, the method as above, receiving the indication of at least one update type comprises one of: receiving multiple DCI via different Transmit/Receive Points (TRPs), each of the DCI indicating one TCI state; or receiving single DCI via different Transmit/Receive Points (TRPs), the single DCI indicating at least one of TCI states.

In one embodiment, the method as above, wherein receiving the indication of at least one combination type, comprises: receiving a Radio Resource Control (RRC) signaling including the indication of at least one combination type.

A method of communication, comprises: receiving, at a terminal device from a network device, an indication of a plurality of TCI states associated with Transmit/Receive Points (TRPs) with different Physical Cell Identifiers (PCIs); selecting a set of TRPs based on a capability information of the terminal device; and receiving, from the set of TRPs, a common information of a plurality of terminal devices.

In one embodiment, the method as above, wherein selecting the set of TRPs, comprises: based on the capability information, selecting serving cell TRP or a TRP with a different PCI from the serving cell TRP based on one of: TCI state ID, CORESET ID or configuration of CORESET 0.

In one embodiment, the method as above, wherein selecting the set of TRPs, comprises: based on the capability information. selecting serving cell TRP or a TRP with a different PCI from the serving cell TRP based on one of: quality of receiving signal of the terminal device, trajectory of the terminal device, or higher layer indication or procedure.

In one embodiment, the method as above, wherein the common information is one of: short message, system information, common Physical Downlink Control Channel (PDCCH), common Physical Downlink Shared Channel (PDSCH), or Common Search Space (CSS), or Synchronization Signal Block (SSB).

A method of communication, comprises: transmitting, at a network device to a terminal device, an indication of at least one update type for updating a first plurality of transmission configuration indication (TCI) states to a second plurality of TCI states, the indication of at least one update type being determined by the network device based on first capability information of the terminal device; and communicating with the terminal device based on the second plurality of TCI states.

In one embodiment, the method as above further comprises: transmitting, at the network device to the terminal device, an indication of at least one combination type for determining the first plurality of TCI states by the terminal device, the indication of at least one combination type being determined by the network device based on second capability information of the terminal device.

In one embodiment, the method as above, wherein further comprises: receiving, from the terminal device, the capability information of the terminal device, the capability information of the terminal device being used by the network device for configuring the first plurality of TCI states, and the capability information of the terminal device comprises at least one of: the information of the capability on whether the terminal device support Simultaneous Transmission from Multiple Panels (STxMP) transmission mode; and the information of the capability on whether the terminal device support both joint TCI states and separated TCI states.

In one embodiment, the method as above, wherein the indication of at least one update type includes a first information for updating at least one of the first plurality of TCI states, the first information indicating the TCI state corresponding to a indicated TCI codepoint in Downlink Control Information (DCI) to be updated.

In one embodiment, the method as above, wherein the indication of at least one update type includes a second information for performing one of the following updates:
updating the TCI states of the first plurality of TCI states for same Transmit/Receive Points (TRPs); updating the TCI states of the first plurality of TCI states for different TRPs; or updating the TCI states of the first plurality of TCI states for a plurality of TRPs.

In one embodiment, the method as above, wherein the indication of at least one update type includes a third information for updating at least part of the TCI states of the first plurality of TCI states.

In one embodiment, the method as above, wherein the indication of at least one update type includes a fourth information for updating one type of TCI state of the first plurality of TCI states.

In one embodiment, the method as above, wherein the indication of at least one update type includes a fifth information for updating the TCI states of the first plurality of TCI states associated with same Physical Cell Identifier (PCI) or different PCI.

In one embodiment, the method as above, wherein: transmitting the TCI state update type indication via one of: Radio Resource Control (RRC) signaling or Media Access Control Control Element (MAC CE); additional bits in a TCI field; oradditional field different from a predefined TCI field.

In one embodiment, the method as above, wherein: transmitting the TCI state update type indication via one of: a field by re-interpretating a Downlink Control Information (DCI) field; or special value set for a DCI field.

In one embodiment, the method as above, transmitting the indication of at least one update type comprises one of: transmitting a plurality of DCI via different Transmit/Receive Points (TRPs), each of the DCI indicating one TCI state; or transmitting single DCI via different Transmit/Receive Points (TRPs), the single DCI indicating at least one of TCI states.

In one embodiment, the method as above, the indication of at least one combination type including a set of fields for determining the first plurality of TCI states.

In one embodiment, the method as above, wherein the set of fields of the indication of at least one combination type comprises: a field indicating the number of TCI states for the TCI codepoint; a field indicating the type of each TCI state for the TCI codepoint; a field indicating whether a TCI state is a downlink TCI state or an uplink TCI state in the same octet; and a field indicating the number of TCI codepoints to be used.

In one embodiment, the method as above, wherein the field indicating the number of TCI states for the TCI codepoint indicates the number of TCI states for each Transmit/Receive Point (TRP) of a plurality of TRPs.

In one embodiment, the method as above, wherein the set of fields of the indication of at least one combination type comprises: a field indicating a plurality of available combination types of TCI states corresponding to a TCI codepoint.

In one embodiment, the method as above, wherein the set of fields of the indication of at least one combination type comprises: a field indicating whether each TCI codepoint has a plurality of TCI states or single TCI state; a field indicating whether a TCI state ID in the same octet is for a certain type of TCI state; a field indicating identity of Transmit/Receive Point (TRP) or Control Resource Set (CORESET) pool; and a field indicating identity of the TCI state.

In one embodiment, the method as above, wherein the indication of at least one combination type includes indication for determining a plurality of available Media Access Control Control Element (MAC CE) formats, the MAC CE formats including combination of at least two TCI states.

In one embodiment, the method as above, wherein transmitting the indication of at least one combination type, comprises: transmitting a Radio Resource Control (RRC) signaling including the indication of at least one combination type.

A method of communication, comprises: transmitting, at a network device to a terminal device, an indication of a plurality of TCI states associated with Transmit/Receive Points (TRPs) with different PCIs; determining a set of TRPs selected by the terminal device, the set of TRPs being selected based on the capability information of the terminal device; and transmitting, to the terminal device, the common information from the set of TRPs.

In one embodiment, the method as above further comprises: receiving a report for determining that the terminal device can receive same common information from the TRPs with different PCIs.

In one embodiment, the method as above further comprises: receiving a capability report for determining that the terminal device can receive the common information from the TRPs with different PCIs.

In one embodiment, the method as above further comprises: receiving a report including TRPs selected by the terminal device.

In one embodiment, the method as above further comprises: selecting the TRPs in the report based on at least one of: quality of receiving signal; trajectory of the terminal device.

In one embodiment, the method as above, wherein the common information is one of: short message; system information; common Physical Downlink Control Channel (PDCCH), common Physical Downlink Shared Channel (PDSCH), or Common Search Space (CSS); or Synchronization Signal Block (SSB).

A terminal device comprises: a processor; and a memory storing computer program codes; the memory and the computer program codes configured to, with the processor, cause the terminal device to perform the method according to the method as above.

A network device comprises: a processor; and a memory storing computer program codes; the memory and the computer program codes configured to, with the processor, cause the network device to perform the method according to the method as above.

A computer readable medium having instructions stored thereon, the instructions, when executed by a processor of an apparatus, causing the apparatus to perform the method according to the method as above.

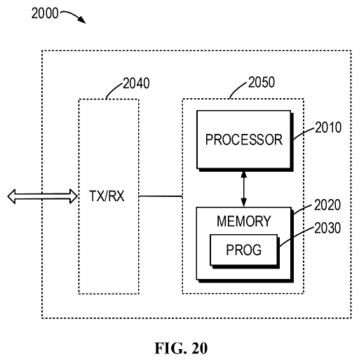

FIG. 20 illustrates a simplified block diagram of a device 2000 that is suitable for implementing embodiments of the present disclosure. The device 2000 can be considered as a further example implementation of the terminal device 110 and/or the network device 120 as shown in FIG. 1. Accordingly, the device 2000 can be implemented at or as at least a part of the terminal device 110 or the network device 120.

As shown, the device 2000 includes a processor 2010, a memory 2020 coupled to the processor 2010, a suitable transmitter (TX) and receiver (RX) 2040 coupled to the processor 2010, and a communication interface coupled to the TX/RX 2040. The memory 2010 stores at least a part of a program 2030. The TX/RX 2040 is for bidirectional communications. The TX/RX 2040 has at least one antenna to facilitate communication, though in practice an Access Node mentioned in this disclosure may have several ones. The communication interface may represent any interface that is necessary for communication with other network elements, such as X2 interface for bidirectional communications between eNBs, S1 interface for communication between a Mobility Management Entity (MME)/Serving Gateway (S-GW) and the eNB, Un interface for communication between the eNB and a relay node (RN), or Uu interface for communication between the eNB and a terminal device.

The program 2030 is assumed to include program instructions that, when executed by the associated processor 2010, enable the device 2000 to operate in accordance with the embodiments of the present disclosure, as discussed herein with reference to FIGS. 3-14. The embodiments herein may be implemented by computer software executable by the processor 2010 of the device 2000, or by hardware, or by a combination of software and hardware. The processor 2010 may be configured to implement various embodiments of the present disclosure. Furthermore, a combination of the processor 2010 and memory 2020 may form processing means 2050 adapted to implement various embodiments of the present disclosure.

The memory 2020 may be of any type suitable to the local technical network and may be implemented using any suitable data storage technology, such as a non-transitory computer readable storage medium, semiconductor-based memory devices, magnetic memory devices and systems, optical memory devices and systems, fixed memory and removable memory, as non-limiting examples. While only one memory 2020 is shown in the device 2000, there may be several physically distinct memory modules in the device 2000. The processor 2010 may be of any type suitable to the local technical network, and may include one or more of general purpose computers, special purpose computers, microprocessors, digital signal processors (DSPs) and processors based on multicore processor architecture, as non-limiting examples. The device 2000 may have multiple processors, such as an application specific integrated circuit chip that is slaved in time to a clock which synchronizes the main processor.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure arc illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 6-20. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1.-20. (canceled)

21. A method, performed by a terminal device, the method comprising:
receiving, from a network device, a radio resource control (RRC) configuration comprising a transmission configuration indication (TCI) state type with a first value or a second value; and
receiving, from the network device, a media access control (MAC) control element (MAC CE) comprising information for a codepoint of a TCI field in downlink control information (DCI) mapped with one or more TCI states,
wherein:
two formats for the MAC CE correspond to the first value and the second value of the TCI state type, respectively,
a first format of the two formats for the MAC CE comprises up to two joint TCI sates for downlink (DL) and uplink (UL) operation mapped to the codepoint, and
a second format of the two formats for the MAC CE comprises up to two DL TCI states and up to two UL TCI states mapped to the codepoint.

22. The method of claim 21, wherein:
the first value of the TCI state type indicates a serving cell is configured with a first TCI state list for a joint TCI state for DL and UL operation, and
the second value of the TCI state type indicates the serving cell is configured with the first TCI state list for a DL TCI state and a second TCI state list for a UL TCI state.

23. The method of claim 21, wherein:
the TCI field indicates multiple TCI states, and
the multiple TCI states comprises two joint TCI states, two downlink (DL) TCI states and two uplink (UL) TCI states, two DL TCI states and one UL TCI states, or one DL TCI states and two UL TCI states.

24. The method of claim 23, wherein:
the one or more TCI states are a sub-set of the multiple TCI states.

25. The method of claim 24, comprising:
updating the sub-set of the multiple TCI states, and keeping a TCI state of the multiple TCI states being not updated by the codepoint.

26. A method, performed by a network device, the method comprising:
transmitting, to a terminal device, a radio resource control (RRC) configuration comprising a transmission configuration indication (TCI) state type with a first value or a second value; and
transmitting, to the terminal device, a media access control (MAC) control element (MAC CE) comprising information for a codepoint of a TCI field in downlink control information (DCI) mapped with one or more TCI states,
wherein:
two formats for the MAC CE correspond to the first value and the second value of the TCI state type, respectively,
a first format of the two formats for the MAC CE comprises up to two joint TCI sates for downlink (DL) and uplink (UL) operation mapped to the codepoint, and
a second format of the two formats for the MAC CE comprises up to two DL TCI states and up to two UL TCI states mapped to the codepoint.

27. The method of claim 26, wherein:
the first value of the TCI state type indicates a serving cell is configured with a first TCI state list for a joint TCI state for DL and UL operation, and
the second value of the TCI state type indicates the serving cell is configured with the first TCI state list for a DL TCI state and a second TCI state list for a UL TCI state.

28. The method of claim 26, wherein:
the TCI field indicates multiple TCI states, and
the multiple TCI states comprises two joint TCI states, two downlink (DL) TCI states and two uplink (UL) TCI states, two DL TCI states and one UL TCI states, or one DL TCI states and two UL TCI states.

29. The method of claim 28, wherein:
the one or more TCI states are a sub-set of the multiple TCI states.

30. The method of claim 29, wherein:
the sub-set of the multiple TCI states is updated, and a TCI state of the multiple TCI states is kept being not updated by the codepoint.

31. A terminal device, comprising a processor configured to cause the terminal device to:
receive, from a network device, a radio resource control (RRC) configuration comprising a transmission configuration indication (TCI) state type with a first value or a second value; and
receive, from the network device, a media access control (MAC) control element (MAC CE) comprising information for a codepoint of a TCI field in downlink control information (DCI) mapped with one or more TCI states,
wherein:
two formats for the MAC CE correspond to the first value and the second value of the TCI state type, respectively,
a first format of the two formats for the MAC CE comprises up to two joint TCI sates for downlink (DL) and uplink (UL) operation mapped to the codepoint, and
a second format of the two formats for the MAC CE comprises up to two DL TCI states and up to two UL TCI states mapped to the codepoint.

32. The terminal device of claim 31, wherein:
the first value of the TCI state type indicates a serving cell is configured with a first TCI state list for a joint TCI state for DL and UL operation, and
the second value of the TCI state type indicates the serving cell is configured with the first TCI state list for a DL TCI state and a second TCI state list for a UL TCI state.

33. The terminal device of claim 31, wherein:
the TCI field indicates multiple TCI states, and
the multiple TCI states comprises two joint TCI states, two downlink (DL) TCI states and two uplink (UL) TCI states, two DL TCI states and one UL TCI states, or one DL TCI states and two UL TCI states.

34. The terminal device of claim 33, wherein the one or more TCI states are a sub-set of the multiple TCI states.

35. The terminal device of claim 34, wherein the processor is configured to cause the terminal device to:
update the sub-set of the multiple TCI states, and keep a TCI state of the multiple TCI states being not updated by the codepoint.
